(19) United States
(12) Patent Application Publication
(10) Pub. No.: US 2024/0237662 A1
(43) Pub. Date: Jul. 18, 2024

(54) AQUEOUS DISPERSIONS OF MAGNESIUM COMPOUNDS FOR USE IN PRESERVATION OF HARVESTED PRODUCTS

(71) Applicant: DEAD SEA BROMINE COMPANY LTD., Beer-Sheva (IL)

(72) Inventors: Mohammed ABUELHAIGA, Kibbutz Mefalsim (IL); Reuven ROZEN, Beer Sheva (IL); Nikolay FUX, Beer Sheva (IL); Alexander FRENKLACH, Lehavim (IL)

(21) Appl. No.: 18/558,804

(22) PCT Filed: May 4, 2022
(86) PCT No.: PCT/IL22/50470

§ 371 Date: Nov. 3, 2023

Related U.S. Application Data
(60) Provisional application No. 63/184,820, filed on May 6, 2021.

(51) Int. Cl. A23B 7/157; A23B 7/16

(52) U.S. Cl. CPC A23B 7/157; A23B 7/16

(57) ABSTRACT

Aqueous suspensions including very slightly water soluble or water-insoluble magnesium compounds such as magnesium oxide and/or magnesium hydroxide, in particular for use in prolonging the shelf life of agricultural food products, such as fruit and vegetables and for protecting harvested produce from decay by fungal infections.

### CROSS-REFERENCE TO RELATED APPLICATIONS

This application is a National Stage application of International Patent Application No. PCT/IL2022/050470, filed on May 4, 2022, which claims priority to U.S. Provisional Patent Application No. 63/184,820, filed on May 6, 2021, each of which is hereby incorporated by reference in its entirety.

### TECHNICAL FIELD

The present disclosure generally relates to aqueous suspensions comprising magnesium oxide and/or magnesium hydroxide for use in prolonging the shelf life of agricultural food products, in particular fruits and vegetables.

### BACKGROUND

Postharvest management of fruits and vegetables, a major source of essential vitamins and minerals, is required for meeting the global demand for fresh produce. Harvested products are metabolically active and undergo ripening and aging processes that must be controlled in order to extend their shelf-life and reduce food waste. Insufficient management of these processes may lead to losses in nutritional and quality features, exposure to foodborne pathogens as well as to financial loss.

By way of example, the main loss of postharvest citrus fruits is caused by the fungi Penicillium digitatum and Penicillium italicum (also termed “green” and “blue” mold, respectively) and by Geotrichum candidum (also termed “sour rot”). Fruit infection mostly occurs through surface injuries of the skin that are inflicted during harvest and subsequent handling. In order to reduce infection rate and subsequently development of decay, there is a need to protect the fruit skin from injury and to eradicate any potential existing infection.

Postharvest treatments of fresh produce generally include, among others, temperature management, irradiation, edible coatings and various chemical agents, aiming to retard aging processes and microbial spoilage. Currently, acceptable methods for managing postharvest decay in citrus fruits comprise application of different agents, among which are fungicides, including peroxy acetic acid (PAA), chlorine, H₂O₂, Thiabendazole (TBZ), sodium o-phenylphenate (OPP), Imazalil, Scholar® (fludioxonil) and Philabuster? (Imazalil and Pyrimethanil)

Compositions for application to fruits, for example apples and cherries, comprising aluminum magnesium silicate were described in the publication WO 2010/124131. Magnesium peroxide was used alongside phosphate salt, chiefly through addition to soil in which plants grow, for protection from various types of fungi as described in the publication WO1993/000311.

In recent years, development and application of soft chemicals and natural materials with reduced toxicity to humans and to the environment has become a necessity, in particular in light of the growing requirement to reduce the use of chemicals in fresh fruits and vegetables. Therefore, additional active materials that are safe and effective in controlling postharvest decay of fresh produce, inter alia, citrus fruit, are being sought.

### SUMMARY

Experimental work conducted in the framework of the present invention shows that decay of fruits was greatly inhibited by applying to the fruits (e.g., citrus fruits) aqueous dispersions comprising very slightly water soluble or water-insoluble magnesium compounds, particularly magnesium oxide (MgO, also termed magnesia) or magnesium hydroxide (Mg(OH)₂), either alone or in admixture with a suspension aid (dispersant), e.g., a phosphate-based dispersant, preferably a water soluble phosphate selected from salts of phosphoric acid, salts of condensed phosphoric acids (pyrophosphoric acid), and salts of polyphosphoric acid. This effect was shown both in wounded fruits and in fruits wounded and inoculated with fungi that typically grows on citrus fruits and contributes to the decay thereof.

These experimental results demonstrate that aqueous dispersions as defined herein possess both protective and killing (or neutralization) properties against fungi, e.g., Penicillium digitatum and Penicillium italicum as well as Geotrichum candidum.

Remarkably, inhibition or reduction of the decay level in infected fruits by application of the aqueous dispersions of the present disclosure was comparable and in some cases even superior to the inhibition or reduction of the decay level in infected fruits on which known fungicides were applied, e.g., imazalil, polyoxin, etc.

The present invention therefore relates to aqueous dispersions comprising at least one magnesium compounds, particularly magnesium oxide and/or magnesium hydroxide, for example in grades as characterized herein below, alone or in combination with at least one suspension aid, e.g., dispersant, for example a water soluble phosphate/pyrophosphate/polyphosphate salt, provided for use in the field of post-harvest product protection, in particular from microbial damage that may be caused during storage and shipping and for lengthening the postharvest life of fruits and vegetables.

The present invention further relates to use of an aqueous dispersion comprising very slightly water soluble or water-insoluble magnesium compounds, preferably at least one of magnesium oxide and/or magnesium hydroxide, and optionally at least one suspension aid (e.g., dispersant) for prolonging the shelf life of agricultural food products (e.g., fruits and vegetables, such as citrus fruits).

In other words, the present invention provides an aqueous dispersion comprising very slightly water soluble or water-insoluble magnesium compounds, preferably magnesium oxide and/or magnesium hydroxide, and optionally at least one suspension aid such as a phosphate-based dispersant, for use in prolonging the shelf life of agricultural food products, such as fruits and vegetables, e.g., citrus fruits.

In some embodiments, the aqueous dispersion as herein defined protects said agricultural food products from decay by fungal infection and/or controls fungi on said agricultural food products.

As a further example, the aqueous dispersion according to the present invention comprises at least 2% magnesium oxide and/or magnesium hydroxide and when present, at least 0.05% by weight of a suspension aid (e.g., a phosphate-based dispersant), based on the total weight of the dispersion. In further specific embodiments, the aqueous dispersion as herein defined comprises:
from 75 to 97.95% by weight of water,
from 2 to 15% by weight of MgO, Mg(OH)₂ or a mixture thereof; and optionally from 0.05 to 3.0%, by weight of a phosphate-based dispersant.

The present disclosure further provides a method for prolonging the shelf life of agricultural food products, e.g., fruits and vegetables, preferably citrus fruits, and./or for protecting agricultural food products from decay by fungal infection and/or for neutralizing fungi on/in agricultural food products, comprising applying to the food products (e.g., just prior to harvest or after harvest thereof) an aqueous dispersion comprising very slightly water soluble or water-insoluble magnesium compounds, for example magnesium oxide and/or magnesium hydroxide or a mixture thereof, optionally in combination with at least one suspension aid (e.g., a dispersant, such as a phosphate-based dispersant). The phosphate-based dispersant as herein defined is a water-soluble salt selected from the group consisting of salts of phosphoric acid; salts of pyrophosphoric acid and salts of polyphosphoric acid.

The method of the present disclosure provides applying to the harvested produce an aqueous dispersion such that magnesium oxide and/or magnesium hydroxide are at a quantity of at least 0.1 gr per 1 kg food products, e.g., 0.1-5.0 gr, preferably 0.5-1.5 gr per 1 kg agricultural food products (e.g., fruits and vegetables, such as citrus fruits), by immersing the food products in the dispersion or spraying the dispersion onto the food products.

In some embodiments, the method as herein defined is for prolonging the shelf life of citrus fruits, comprising applying to the citrus fruits an aqueous dispersion comprising at least 2% magnesium oxide and/or magnesium hydroxide and when present, at least 0.05% by weight of a suspension aid, based on the total weight of the dispersion, by immersing the food products in the dispersion or spraying the dispersion onto the food products.

Experimental evidence show that the aqueous dispersion of the present disclosure imparts to the fruits anti-fungal properties such that growth is retarded both for environmental fungi (i.e., a protective effect) and for fungi already inoculated into the fruits. The method of prolonging the shelf life of agricultural food products is particularly applicable to agricultural food products (e.g., fruits and vegetables) stored under refrigeration or ambient conditions. It has been shown that under these conditions, development of decay due to fungi growth is retarded by about 1 to 4 weeks.

Thus, the present invention provides a method for protecting harvested produce from decay by fungal infection and/or for controlling fungi on harvested produce. The methods as herein defined are particularly applicable for inhibiting or at least reducing the rate of decay of agricultural food products due to fungi growth, e.g., Penicillium digitatum, Penicillium italicum or Geotrichum candidum growth, thereby food products decay is retarded.

In particular, the dispersion/suspension of the present disclosure may be prepared using MgO characterized by having a particle size distribution with d₁₀ ranging from 0.5 to 1.5 μm, by a d₅₀ ranging from 1.5 to 6.0 μm and by a doo ranging from 5.0 to 45 μm, a surface area ranging from 5.0 to 25.0 m²/gr, LOI ranging from 0.2 to 5.0%, bulk density ranging from 0.30 to 0.50 gr/ml and by citric acid activity (40) ranging from 80 to 200 seconds.

### BRIEF DESCRIPTION OF THE DRAWINGS

Embodiments will now be described, by way of non-limiting example only, with reference to the accompanying drawings, in which:

FIGS. 1A-1C are bar graphs showing decay percentage in white grapefruits infected with Penicillium digitatum. Infected grapefruits were left untreated (“1”), waxed only (“2”) or immersed in an aqueous dispersion comprising a phosphate-based dispersant (PBD) and magnesium oxide (MgO) at 0.1% and 5%, respectively, by weight out of the total weight of the dispersion (“3”), PBD and MgO at 0.125% and 5%, respectively (“4”), PBD at 2% (“5”), PBD at 2.5% (“6”) or MgO at 5% (“7”), dried and waxed, and stored at 10° C. for two weeks and then moved to 20° C. for up to five days. A bar graph showing decay percentage in the different fruit groups after 14 days at 10° C. is shown in FIG. 1A. A bar graph showing decay percentage in the different fruit groups after two weeks at 10° C. and two days at 20° C. is shown in FIG. 1B and a bar graph showing the decay percentage in the different fruit groups after two weeks at 10° C. and five days at 20° C. is shown in FIG. 1C.

FIGS. 2A-2G are photographs of grapefruits treated as described in connection with FIG. 1C, namely of infected fruits left untreated (FIG. 2A), waxed only (FIG. 2B) or immersed in an aqueous dispersion comprising PBD and MgO at 0.1% and 5%, respectively (FIG. 2C), PBD and Mg(at 0.125% and 5%, respectively (FIG. 2D), PBD at 2% (FIG. 2E), PBD at 2.5% (FIG. 2F) or MgO at 5% (FIG. 2G), dried and waxed thereafter and then stored two weeks at 10° C. and five days at 20° C.

FIGS. 3A-3D are bar graphs showing decay percentages in white grapefruits that were infected with Penicillium digitatum and 4 or 24 hours thereafter were left untreated (“1”), waxed only (“2”) or immersed in an aqueous dispersion comprising PBD and MgO at 0.125% and 5%, respectively, without (“3”) or with (“4”) a waxing step, immersed in an aqueous dispersion comprising PBD, MgO and aluminum ammonium polyphosphate (AG) at 0.125%, 5% and 0.3% by weight out of the total weight of the dispersion, respectively, without (“5”) or with (“6”) a waxing step, or in white grapefruits infected with Penicillium digitatum and 4 hours post infection immersed in an aqueous dispersion comprising mono ammonium phosphate (MAP) and MgO at 0.125% and 5%, respectively, without (“7”) or with (“8”) a waxing step and stored at 10° C. for two weeks and then zero (FIG. 3A), two (FIG. 3B), five (FIG. 3C) or seven (FIG. 3D) days at 20° C.

FIGS. 4A and 4B are photographs of grapefruits treated as described in connection with FIG. 3D, namely that were infected with Penicillium digitatum and 4 hours thereafter were left untreated (“control”) in the absence (FIG. 4A) or in the presence (FIG. 4B) of a waxing step.

FIGS. 5A and 5B are photographs of grapefruits treated as described in connection with FIG. 3D, namely that were infected with Penicillium digitatum and 24 hours thereafter were left untreated (“control”) in the absence (FIG. 5A) or in the presence (FIG. 5B) of a waxing step.

FIGS. 6A and 6B are photographs of grapefruits treated as described in connection with FIG. 3D, namely that were infected with Penicillium digitatum and 4 hours thereafter were immersed in an aqueous dispersion comprising PBD and MgO at 0.125% and 5%, respectively, in the absence (FIG. 6A) or in the presence (FIG. 6B) of a waxing step.

FIGS. 7A and 7B are photographs of grapefruits treated as described in connection with FIG. 3D, namely that were infected with Penicillium digitatum and 24 hours thereafter were immersed in an aqueous dispersion comprising PBD and MgO at 0.125% and 5%, respectively, in the absence (FIG. 7A) or in the presence (FIG. 7B) of a waxing step.

FIGS. 8A and 8B are photographs of grapefruits treated as described in connection with FIG. 3D, namely that were infected with Penicillium digitatum and 4 hours thereafter were immersed in an aqueous dispersion comprising PBD, MgO and aluminum ammonium polyphosphate (AG) at 0.1%, 5% and 0.3%, respectively, in the absence (FIG. 7A) or in the presence (FIG. 8B) of a waxing step.

FIGS. 9A and 9B are photographs of grapefruits treated as described in connection with FIG. 3D, namely that were infected with Penicillium digitatum and 24 hours thereafter were immersed in an aqueous dispersion comprising PBD, MgO and aluminum ammonium polyphosphate (AG) at 0.1%, 5% and 0.3%, respectively, in the absence (FIG. 9A) or in the presence (FIG. 9B) of a waxing step.

FIGS. 10A and 10B are photographs of grapefruits treated as described in connection with FIG. 3D, namely that were infected with Penicillium digitatum and 4 hours thereafter were immersed in an aqueous dispersion comprising MAP and MgO at 0.125% and 5%, respectively, in the absence (FIG. 10A) or in the presence (FIG. 10B) of a waxing step.

FIG. 11 is a bar graph showing decay percentage in white grapefruits infected with Penicillium digitatum 4 hours prior to treatment. Infected grapefruits were left untreated (“1”), waxed only (“2”) or immersed in an aqueous dispersion comprising MgO at 5% and dried, without (“3”) or with (“4”) a waxing step, immersed in an aqueous dispersion comprising PBD at 0.125% and dried, without (“5”) or with (“6”) a waxing step, immersed in an aqueous dispersion comprising PBD and MgO at 0.125% and 5%, respectively, and dried, without (“7”) or with (“8”) a waxing step, or immersed in an aqueous dispersion comprising PBD and MgO at 0.125% and 5%, respectively, dried and washed thereafter, without (“9”) or with (“10”) a waxing step. Treated grapefruits were stored nine (9) days at 10° C. and monitored for decay after zero (0), three (3), five (5) or seven (7) days at 20° C.

FIGS. 12A-12J are photographs of grapefruits treated as described in connection with FIG. 11, specifically that were stored at 10° C. for nine (9) days and then stored at 20° C. for five (5) days. Infected grapefruits left untreated are shown in FIG. 12A, infected grapefruits waxed only are shown in FIG. 12B. Infected grapefruits that were immersed in an aqueous dispersion comprising MgO at 5% and dried without or with a waxing step, are shown in FIG. 12C and FIG. 12D, respectively. Infected grapefruits immersed in an aqueous dispersion comprising a phosphate-based dispersant at 0.125% and dried without or with a waxing step are shown in FIG. 12E and in FIG. 12F, infected grapefruits that were immersed in an aqueous dispersion comprising a phosphate-based dispersant and MgO at 0.125% and 5%, respectively, and dried without or with a waxing step are shown in FIG. 12G and in FIG. 12H. FIG. 12I and FIG. 12J show infected grapefruits that were immersed in an aqueous dispersion comprising a phosphate-based dispersant and MgO at 0.125% and 5%, respectively, dried and washed without (FIG. 12I) or with (FIG. 12J) a waxing step.

FIG. 13 is a bar graph showing the effect of coating Penicillium digitatum-infected red grapefruits with dispersions comprising magnesium oxide alone or in combination with Xantan gum (“MgO+xan”) or with a phosphate-based dispersant (“MgO+PBD”), or with dispersions comprising magnesium hydroxide in combination with Xanthan gum (“Mg(OH)2+xan”) or a phosphate-based dispersant (“Mg(OH)2+PBD”) on the decay percentage of the fruits. Treated fruits were stored 12 days at 7° C., moved to storage of a week at 20° C. and monitored for decay after zero (0), 5, 7 or 14 days at 20° C. Abbreviations: cont., control; xan, Xantan gum; PBD, phosphate-based dispersant.

FIG. 14 is a bar graph showing the effect of coating Penicillium italicum-infected red grapefruits with dispersions comprising magnesium oxide alone or in combination with Xantan gum (“MgO+xan”) or with a phosphate-based dispersant (“MgO+PBD”) on the decay percentage of the fruits. After coating, treated fruits were stored 12 days at 7° C., moved to storage at 20° C. and monitored for decay after zero (0) or 2, 5, 7 or 14 days at 20° C. Abbreviations: cont., control; xan, Xantan gum; PBD, phosphate-based dispersant.

FIG. 15 is a bar graph showing the effect of coating wounded (i.e., injured twice without infecting with fungi) red grapefruits with dispersions comprising magnesium oxide alone or in combination with Xantan gum (“MgO+xan”) or with a phosphate-based dispersant (“MgO+PBD”) or with dispersions comprising magnesium hydroxide in combination with Xanthan gum (“Mg(OH)2+xan”) or in combination with a phosphate-based dispersant (“Mg(OH)2+PBD”) on the decay percentage of the fruits. After coating, treated fruits were stored 12 days at 7° C., moved to storage of a week at 20° C. and monitored for decay after zero (0), 2, 5, 7 or 14 days at 20° C. Abbreviations: cont., control; xan, Xantan gum; PBD, phosphate-based dispersant.

FIG. 16 is a bar graph showing the effect of dipping Penicillium digitatum-infected oranges in water or coating thereof in a dispersion comprising magnesium bicarbonate (Mg²⁺, 1500 ppm) on the decay percentage of the fruits. After coating, the fruits were stored for 24 hours at 20° C. and monitored for decay after 2 or 24 hours. Abbreviations: h, hours.

FIG. 17 is a photograph showing control oranges, infected with Penicillium digitatum.

FIGS. 18A and 18B are photographs showing Penicillium digitatum-infected oranges coated by a dispersion comprising magnesium bicarbonate (FIG. 18A) or that were dipped in water (FIG. 18B) after storage of 2 hours at 20° C.

FIGS. 19A and 19B are photographs showing Penicillium digitatum-infected oranges coated by a dispersion comprising magnesium bicarbonate (FIG. 19A) or that were dipped in water (FIG. 19B) after storage of 24 hours at 20° C.

FIGS. 20A-20E are bar graphs showing decay percentages in Or mandarins that were infected with Geotrichum candidum and 4 or 24 hours post infection were waxed only (“control”) or coated by a suspension comprising MgO alone (“5% MgO”) or by a suspension comprising MgO in combination with PBD (“MgO+PBD”). The weight percentage of the phosphate-based dispersing agent is provided based on the weight of MgO in the dispersion, i.e., the concentrations of MgO and the PBD were 5% and 0.125%, respectively, by weight based on the total weight of the dispersion. Decay percentage is shown after storage of four days (FIG. 20A), six days (FIG. 20B), eight days (FIG. 20C), 11 days (FIG. 20D) or 14 days (FIG. 20E) of the infected and treated fruits at 20° C.

FIGS. 21A and 21B are bar graphs showing decay percentages in oranges that were infected with Penicillium digitatum and 24 hours post infection were waxed (treatment “1”), washed in water and then waxed (treatment “2”), or coated by a dispersion comprising MgO and PBD at 5% and 0.125% by weight of the total weight of the dispersion, respectively, dried and waxed (treatment “3”) or that were treated by a solution comprising imazalil at 500 ppm (treatment “4”). Decay percentage is shown after storage of 11 days at 5° C. (FIG. 21A) and after storage of 11 days at 5° C. and nine (9) days at 20° C. (FIG. 21B).

FIGS. 22A-22D are photographs showing Penicillium digitatum-infected oranges that were treated 24 hours post infection and then stored 11 days at 5° C. and nine (9) days at 20° C., where fruits treated by a waxing step only are shown in FIG. 22A, fruits treated by washing in water and then waxing are shown in FIG. 22B, fruits treated by application of a dispersion comprising MgO and PBD at 5% and 0.125% by weight of the total weight of the dispersion, respectively, and then dried and waxed are shown in FIG. 22C and fruits that were treated by application of an imazalil solution (500 ppm) and then waxed are shown in FIG. 22D.

FIG. 23 is a bar graph showing decay percentages in lemons that were infected with Geotrichum candidum and 24 hours post infection were waxed only (control), coated by a dispersion comprising MgO and PBD (at 5% and 0.125% by weight of the total weight of the dispersion, respectively), then dried and waxed (“MgO+PBD”) or that were treated by a solution comprising polyoxin in wax (at 1000 or 2000 ppm). Decay percentages are shown after storage of 2, 5, 6 or 7 days at 20° C.

FIGS. 24A-24D are photographs showing Geotrichum candidum-infected lemons that 24 hours post infection were waxed only (FIG. 24A), coated by a dispersion comprising MgO and PBD (at 5% and 0.125% by weight of the total weight of the dispersion, respectively), then dried and waxed (FIG. 24B) or that were treated by a solution comprising polyoxin in wax at 1000 ppm or 2000 ppm (FIG. 24C and FIG. 24D, respectively). Fruit appearance is shown after storage of 5 days at 20° C.

FIG. 25 is a bar graph showing decay percentages in navel oranges that were infected with Geotrichum candidum and 24 hours post infection were left un-treated (control), coated by a dispersion comprising MgO and PBD (at 5% and 0.125% by weight of the total weight of the dispersion, respectively) or that were treated by a solution comprising polyoxin in wax at 1000 or 2000 ppm. Decay percentages are shown after storage of 5, 7, 9 or 13 days at 20° C.

FIG. 26 is a bar graph showing decay percentages in red grapefruits that were infected with Geotrichum candidum and 24 hours post infection were left un-treated (control), coated by a dispersion comprising MgO and PBD (at 5% and 0.125% by weight of the total weight of the dispersion, respectively) or that were treated by a solution comprising polyoxin in wax at 1000 or 2000 ppm. Decay percentages are shown after storage of 5, 7 or 12 days at 25° C.

FIGS. 27A-27D are photographs showing Geotrichum candidum-infected red grapefruits that 24 hours post infection were left un-treated (FIG. 27A), coated by a dispersion comprising MgO and PBD (FIG. 27B) or that were treated by a solution comprising polyoxin in wax at 1000 ppm or 2000 ppm (FIG. 27C and FIG. 27D, respectively). Fruit appearance is shown after storage of 7 days at 25° C.

FIG. 28 is a bar graph showing decay percentages in clementines that were infected with Geotrichum candidum and 24 hours post infection were left un-treated (control), coated by a dispersion comprising MgO and PBD (at 5% and 0.125% by weight of the total weight of the dispersion, respectively), that were treated by a solution comprising polyoxin at 3000 or 4000 ppm or that were treated by a solution comprising polyoxin in wax, where polyoxin was at 4000 ppm. Decay percentages are shown after storage of 5, 7, 8 or 12 days at 25° C.

FIGS. 29A-29E are photographs showing Geotrichum candidum-infected clementines that 24 hours post infection were left un-treated (FIG. 29A), coated by a dispersion comprising MgO and PBD (FIG. 29B), that were treated by a solution comprising polyoxin at 3000 or 4000 ppm (FIG. 29C or FIG. 29D, respectively) or that were treated by a solution comprising polyoxin in wax where polyoxin was at 4000 ppm (FIG. 29E). Fruit appearance is shown after storage of 8 days at 25° C.

FIG. 30 is a bar graph showing decay percentages in Newhall oranges that were infected with Geotrichum candidum and 24 hours post infection were left un-treated (control), coated by a dispersion comprising MgO and PBD (at 5% and 0.125%, respectively), that were treated by a solution comprising polyoxin in wax (at 3000 ppm), a solution comprising MgO and polyoxin (at 5% and 3000, respectively), or that were treated by a solution comprising guazatine (at 1500 ppm). Decay percentages are shown after storage of 13 days at 25° C.

FIG. 31 is a bar graph showing decay percentages in Cara Cara oranges that were infected with Geotrichum candidum and 24 hours post infection were left un-treated (control), coated by a dispersion comprising MgO and PBD (at 5% and 0.125%, respectively), that were treated by a solution comprising polyoxin in wax (at 3000 ppm), a solution comprising MgO and polyoxin (at 5% and 3000 ppm, respectively), or that were treated by a solution comprising guazatine (at 1500 ppm). Decay percentages are shown after storage of 5, 7 or 9 days at 25° C. Abbreviations: Polyox, polyoxin.

FIGS. 32A-32E are photographs showing Geotrichum candidum-infected Cara Cara oranges that 24 hours post infection were left un-treated (FIG. 32A), coated by a dispersion comprising MgO and PBD (at 5% and 0.125%, respectively FIG. 32B), that were treated by a solution comprising polyoxin in wax (at 3000 ppm, FIG. 32C), a solution comprising MgO and polyoxin (at 5% and 3000 ppm, respectively, FIG. 32D), or that were treated by a solution comprising guazatine (at 1500 ppm, FIG. 32E). Fruit appearance is shown after storage of 7 days at 25° C.

FIG. 33 is a bar graph showing decay percentages in white grapefruits that were infected with Penicillium digitatum and 9 days post infection were left un-treated (control), coated by a dispersion comprising Imazalil and TBZ (at 500 ppm and 3 ppm, respectively) or MgO in combination with PBD (at 5% and 0.125%, respectively). Decay percentages are shown after storage of 4, 5 or 7 days at 20° C.

FIGS. 34A-34C are photographs showing white grapefruit that were infected with Penicillium digitatum and 9 days post infection were left un-treated (FIG. 34A), coated by a dispersion comprising Imazalil and TBZ (at 500 ppm and 3 ppm, respectively, FIG. 34B) or MgO and PBD (at 5% and 0.125%, respectively, FIG. 34C). Fruit appearance is shown after storage of 5 days at 20° C.

FIG. 35 is a bar graph showing decay percentages in mandarins that were infected with Penicillium digitatum and 9 days post infection were left un-treated (control), coated by a dispersion comprising Imazalil and TBZ (at 500 ppm and 3 ppm, respectively) or MgO and PBD (at 5% and 0.125%, respectively). Decay percentages are shown after storage of 4, 5 or 7 days at 20° C.

FIGS. 36A-36C are photographs showing white mandarins that were infected with Penicillium digitatum and 9 days post infection were left un-treated (FIG. 36A), coated by a dispersion comprising Imazalil and TBZ (at 500 ppm and 3 ppm, respectively, FIG. 36B) or MgO and PBD (at 5% and 0.125%, respectively, FIG. 36C). Fruit appearance is shown after storage of 5 days at 20° C.

FIG. 37 is a bar graph showing decay percentages in kumquat oranges that were left untreated (control) or coated with a dispersion comprising MgO and PBD (at 5% and 0.125%, respectively) over 22 days at 5° C. and up to 19 days at 20° C.

### DETAILED DESCRIPTION

In its most general form, preparation of magnesium oxide is based on calcination of magnesium hydroxide. The temperature profile in the calcination kiln influences the properties and activity of the resultant magnesium oxide. In the Aman process, magnesium oxide is first formed by the decomposition of hydrated magnesium chloride; subsequent washing results in hydration, i.e., hydroxide formation, which is then calcined back to give the oxide in a pure form. Another industrial approach is based on precipitation of magnesium hydroxide from brine by addition of an alkaline agent, e.g., calcium hydroxide, sodium hydroxide or ammonium hydroxide, and then calcination to produce the oxide.

Grades of magnesium oxide suitable for use in the invention are selected to satisfy a set of criteria, e.g.:
particle size distribution (PSD) characterized by d₁₀, d₅₀ and doo values such that d₁₀≤1.5 μm (e.g. from 0.1 to 1.5 μm, from 0.5 to 1.0 μm or from 0.8 to 1.3 μm), 1.5 μm≤d₅₀≤6.0 μm (e.g. from 1.5 to 5.0 μm) and 5.0 μm≤ d₉₀≤45.0 μm, for example 8.0 μm≤c≤45.0 μm or 5.0 μm≤ d₉₀≤30 μm (measured by laser diffraction).
specific surface area above 5.0 m²/gr, preferably from 5.0 to 25.0 m²/gr, more preferably from 5.0 to 15.0 m²/gr, more preferably from 5.0 to 10 m²/gr or from 5.0 to 9 m²/gr (measured by the BET method).
Citric acid activity (CAA 40) ranging from 25 to 300 seconds, preferably from 80 to 200 seconds, e.g. from 150 to 200 seconds.
Loss on ignition (LOI, a measure of residual content of magnesium hydroxide) in the range of 0.1 to 8.0% by weight, e.g., from 4.0 to 8.0%, preferably from 0.2 to 3.0% or from 0.2 to 1.0% by weight.
Bulk density in the range of 0.25 to 0.60 gr/ml, for example between 0.30 and 0.40 gr/ml or from 0.25 to 0.35 gr/ml.

Grades meeting the properties set for the above are available on the marketplace (e.g., from ICL-IP). An illustrative preparation of MgO for use in the invention is based on milling (dry milling) of MgO product obtained by calcination of magnesium hydroxide at temperature in the range of 600 to 950° C. Alternatively, preparation of MgO for use in the framework of the invention may be based on wet milling of magnesium hydroxide before the calcination step mentioned above.

In particular, the Examples shown below were conducted with MgO prepared as described in Preparation 1 below. Thus, the dispersion/suspension of the present disclosure may be prepared using MgO characterized by having a particle size distribution with d₁₀ ranging from 0.5 to 1.5 μm, by a d₅₀ ranging from 1.5 to 6.0 μm and by a doo ranging from 5.0 to 45 μm, a surface area ranging from 5.0 to 25.0 m²/gr, LOI ranging from 0.2 to 5.0%, bulk density ranging from 0.30 to 0.50 gr/ml and by citric acid activity (40) ranging from 80 to 200 seconds.

The dispersion/suspension of the present disclosure may be also prepared using other grades of MgO, for example, such grade which is characterized by having a particle size distribution with d₁₀ ranging from 0.8 to 1.5 μm, by a d₅₀ ranging from 2.5 to 6.0 μm and by a d₉₀ ranging from 10.0 to 45 μm, a surface area ranging from 5.0 to 15.0 m²/gr, LOI ranging from 2.0 to 8.0%, bulk density ranging from 0.25 to 0.35 gr/ml and by citric acid activity (40) ranging from 100 to 200 seconds.

The dispersion/suspension of the present disclosure may be further prepared using an MgO grade, which is characterized by having a particle size distribution with d₁₀ ranging from 1.0 to 1.5 μm, by a d₅₀ ranging from 2.5 to 6.0 μm and by a doo ranging from 10.0 to 45.0 μm, a surface area ranging from 5.0 to 10.0 m²/gr, LOI ranging from 0.2 to 6.0%, bulk density ranging from 0.3 to 0.5 gr/ml and by citric acid activity (40) ranging from 100 to 200 seconds.

Grades of magnesium hydroxide suitable for use in the invention are selected to satisfy a set of criteria, e.g.: a grade characterized by, among others, particle size distribution with d₅₀ in the range of 1.1-1.4 μm, a grade characterized by, among others, particle size distribution with d₅₀ in the range of 1.8-2.3 μm, a grade characterized by, among others, particle size distribution with d₅₀ in the range of 1.45-1.75 μm, a grade characterized by, among others, particles with tapped density of 0.5 gr/cc, a grade characterized by, among others, particles with tapped density of 0.7 gr/cc, a grade characterized by, among others, particles with tapped density 0.9 gr/cc or a grade characterized by, among others, particles with tapped density of 1.0 gr/cc.

The physical properties of magnesium oxide and magnesium hydroxide suitable for use in the present disclosure can be determined based on methods well known in the art.

To prepare an aqueous suspension/dispersion of MgO or Mg(OH)₂, powder of the relevant magnesium compounds (e.g. MgO) is mixed with water, optionally in the presence of one or more suspension aid(s), for example dispersant(s), with the aid of a dissolver stirrer/disperser operating at 5,000 to 10,000 revolutions per minute (rpm), on a laboratory scale (e.g. using high shear mixing instrument). The aqueous suspension/dispersion as herein defined may further comprise additives, for example fungicides for agricultural use, which are commercially available (e.g. imazalil).

A stable suspension/dispersion of MgO or Mg(OH)₂, for example MgO, in water is formed with magnesium compound(s) content of not less than 2%, e.g., from 2 to 15%, from 2 to 10%, from 2 to 6%, preferably from 2 to 5% by weight based on the total weight of the magnesium compound(s) suspension/dispersion. When present, the concentration of the suspension aid (e.g., dispersant) is not less than 0.05%, e.g., not less than 0.1%, for example from 0.05 to 1.0%, from 0.1 to 1.0%, preferably from 0.1 to 0.5% by weight based on the total weight of the dispersion. The suspension/dispersion may further comprise a fungicide. When present in the suspension/dispersion of the present disclosure, the fungicide may be at a concentration of e.g., 500 ppm. Generally, application of 0.1-5.0 gr, e.g. 0.1-2.0 gr, preferably 0.5-1.5 gr magnesium oxide and/or magnesium hydroxide per 1 kg agricultural food products is effective.

Accordingly, preferred aqueous suspension/dispersion of the invention comprises (percentage by weight based on the total weight of the magnesium aqueous dispersion):
from 75 to 97.95% by weight of water, e.g., 80 to 97.95% or 84 to 97.95%;
from 2 to 15% by weight of MgO or Mg(OH)₂; e.g., from 2 to 10% or from 2 to 6%; and optionally
from 0.05 to 3.0%, e.g., 0.1 to 1.0% by weight of a suspension aid (e.g., a dispersant), preferably from 0.1 to 0.5%.

It should be understood that the term “aqueous dispersion” (used interchangeably with “aqueous suspension”) for the purpose of the present disclosure means the dispersion of solids (powders) and additives described herein in an aqueous carrier. The aqueous dispersion is usually characterized by a concentration of solids ranging from 2% by weight to 15% by weight of the total weight of the aqueous dispersion/suspension. The solid content includes all the components of the dispersion except for the aqueous carrier, such as the magnesium compounds (e.g., MgO or Mg(OH)₂) powder, the suspension aid (dispersant) powder (e.g., a phosphate-based dispersant, such as for example, aluminum ammonium phosphate or mono ammonium phosphate, when present), etc.

The present invention further provides an aqueous dispersion for prolonging the shelf life of agricultural food products (e.g., fruits and vegetables), the dispersion comprising MgO (preferably characterized as described above) and/or Mg(OH)₂, and at least one suspension aid (dispersant), e.g., a phosphate-based dispersant (also termed herein PBD), for example water soluble phosphate/pyrophosphate/polyphosphate salt.

The suspension aid (e.g. dispersant) suitable for use in accordance with the present invention may be any inorganic dispersant, e.g., water soluble phosphate/pyrophosphate/polyphosphate salt, for example but not limited to commercially available mono ammonium phosphate (also termed herein MAP), ammonium phosphate or ammonium polyphosphate. Other approaches to stabilize the suspension and minimize settling include the use of xanthan gum, as described in U.S. Pat. No. 4,834,957, or other conventional suspension aids based on cellulose derivatives (e.g., carboxymethyl cellulose).

Yet another additive that may be included in the dispersion is a multivalent metal complex of ammonium polyphosphate as described in WO 2016/199145, in particular in reference to U.S. Pat. No. 8,524,125, i.e., the reaction product of a condensed form of phosphoric acid (super phosphoric acid); a source of multivalent metal (e.g., aluminum compound such as Al(OH)₃); and ammonium hydroxide, which can be recovered as a white, water insoluble, free-flowing fine powder, namely, aluminum ammonium polyphosphate or aluminum ammonium superphosphate, in an amorphous form, with high phosphorus content of above 60% by weight, e.g., of 70% to 80% by weight, measured as PO₄³⁻; nitrogen content of above 8% by weight, e.g., of 9 to 10% by weight, measured as NH₄⁺; Al content of above 5% by weight, e.g., of 6 to 8% by weight; and water content of ˜5 to 10% by weight. A suitable commercially available product is TexFRon® AG from ICL-IP at a particle size distribution of d₁₀<5 microns, d₉₀<15 microns and d₉₉<35 microns.

However, the MgO or Mg(OH)₂-containing suspensions of the invention exhibit food antifungal effect on their own and are generally devoid of the water-insoluble aluminum ammonium polyphosphate, i.e., the water-insoluble component is MgO or Mg(OH)₂.

The co-dispersion according to the present disclosure comprising MgO and/or Mg(OH)₂ and at least one suspension aid (dispersant) may be prepared by first separately formulating or dispersing each one of the magnesium component and the suspension aid (dispersant) or by codispersing both. The weight ratio of the magnesium compounds to the dispersant in the coformulation is, for example but not limited to, in the range of 100:1 to 10:1, e.g., from 70:1 to 20:1, e.g., from 60:1 to 30:1.

The suspension/dispersions described herein may further contain customary additives. Major types of additives include:
one or more surfactants, e.g., emulsifiers, wetting agents, dispersants/wetting agent combinations;
one or more fungicides, e.g., imazalil.

The experimental results presented below show that by applying onto wounded/infected citrus fruits aqueous dispersions comprising magnesium oxide or magnesium hydroxide, either alone or in admixture with a phosphate-based dispersant, decay of the fruits by way of fungal infection was greatly inhibited.

Therefore, in a further aspect thereof the present disclosure provides a method of prolonging the shelf life of agricultural food products, e.g., fruits and vegetables (such as but not limited to citrus fruits), the method comprising applying to the food products an aqueous dispersion comprising very slightly water soluble or water-insoluble magnesium compounds, with solubility below 50 mg/L, e.g., below 10 mg/L (at room temperature), such as water-insoluble magnesium oxide or magnesium hydroxide compounds, the solubility in water thereof is below 6.5 mg/L (at room temperature), and optionally at least one suspension aid (dispersant). The method of the present disclosure is imparting to the food products anti-fungal properties, and is therefore intended, e.g., for protecting harvested produce (such as citrus fruits) from decay by fungal infection and/or for controlling fungi on harvested produce.

As known in the art, by the term “shelf life” it is referred to the length of time that products, especially food products such as agricultural food products, can be stored in refrigeration (e.g., 4-10° C.) and/or at ambient temperature, for example between about 20 and 25° C. before becoming unusable or inedible. Suitability for use of the food products in the context of the present invention may be determined by considerations well known in the art, for example as detailed herein below for fruits. The Examples below show results obtained for storage periods, inter alia at ambient conditions, e.g., between two days and two weeks (14 days), simulating the shelf life of citrus fruits and demonstrate that decay was retarded, and therefore shelf life was prolonged or extended, for example by at least one week, e.g., by at least two weeks.

Thus by the term “prolonging the shelf life” it is meant inhibiting or at least reducing the rate of decay of agricultural food products such as fruits and vegetables, e.g., due to growth of fungi thereon or that the development of decay due to fungi growth on agricultural food products (e.g., fruits and vegetables) is retarded and consequently agricultural food products are thereby stored for longer periods of time in refrigeration (e.g., 4-10° C.) and/or at ambient temperatures.

By way of example, the method as herein defined of prolonging the shelf life of agricultural food products, is wherein said shelf life of food products, e.g., fruits and vegetables such as citrus fruits is extended by at least three days, five days seven days, two weeks, three weeks or four weeks, under storage in the refrigerator and/or at ambient temperature, before the quality and appearance of the produce deteriorates to an extent that the produce is rejected and/or is considered unacceptable, marking the end of the shelf life.

As appreciated by those skilled in the art, by the terms “protecting harvested produce from decay by fungal infection and/or controlling fungi on harvested produce” it is meant inhibiting, restricting, retarding, reducing or diminishing decay in harvested produce, e.g., by at least about 1%-100%, about 5%-95%, about 10%-90%, about 15%-85%, about 20%-80%, about 25%-75%, about 30%-70%, about 35%-65%, about 40%-60% or about 45%-55% as compared to un-treated harvested produce.

The present disclosure is particularly applicable to agricultural food products (interchangeably referred to herein as “harvested produce”) which are fruits and vegetables. A non-limiting list of agricultural products, whose postharvest life can be lengthened according to the invention, includes fruits and vegetables the post-harvest handling thereof generally includes waxing. By way of example, the agricultural food products or harvested produce encompassed by the present invention are fruits, such as citrus fruits, papya, mango and avocado species, to name but few.

As shown below, inhibition of fruit decay was demonstrated for ample types of citrus fruits, such as grapefruits, oranges, mandarins, lemons, clementines, pomelos and kumquats. Preferred and non-limiting agricultural food products are thus fruits of citrus trees and shrubs (belonging to the rue family, Rutaceae) and any variety or species thereof, e.g., grapefruits (e.g., white or red), oranges (e.g., Shamouti, Valencia, Washington or Washington navel), mandarins, lemons, clementines, limes and kumquats.

The experimental results below show effective inhibition of fruit infections caused by the Penicillium fungi Penicillium digitatum and Penicillium italicum as well as by the fungus Geotrichum candidum (also termed “sour rot”). Therefore, the present disclosure particularly encompasses protecting agricultural food products (e.g., fruits and vegetables, for example citrus fruits) from fungal infection resulting from any fungus species associated with food spoilage, and preferably retarding the decay of agricultural food products such as fruits and vegetables (e.g., citrus fruits) due to mold growth on fruits and vegetables after harvesting or due to sour rot.

As known in the art, fungi include microorganisms such as yeasts and molds. While fungi that can adopt a single-celled growth habit are called yeast, a mold grows in the form of multicellular filaments termed “hyphae”. Molds include numerous species, for example of the genera Acremonium, Alternaria, Aspergillus, Cladosporium, Fusarium, Mucor, Penicillium (e.g. Penicillium digitatum and Penicillium italicum to name but few), Rhizopus, Stachybotrys, Trichoderma and Trichophyton. Growth of mold hyphae results in discoloration, especially on food. The hyphae are generally transparent and the mycelium appears as very fine, fluffy white threads over the surface. Molds cause biodegradation of natural materials (resulting in food spoilage). Some diseases of animals and humans can be caused by certain molds, resulting from allergic sensitivity to mold spores, from growth of pathogenic molds within the body, or from the effects of ingested or inhaled toxic compounds (mycotoxins) produced by molds.

Particular fungi as herein defined encompassed by the present invention are fungal species of the division (phylum) Ascomycota. Ascomycota include, but are not limited to fungi of the class Saccharomyceses, such as of the order Saccharomyces, e.g., of the family Dipodascaceae, for example species of the genus Geotrichum, e.g., Geotrichum candidum (also referred to as Oidium lactis and Oospora lactis), which are classified at the boundary between typical yeasts and molds. Ascomycota further include fungal species of the class Eurotiomycetes, such as of the order Eurotiales, for example of the family Trichocomaceae, e.g., species of the genus Penicillium (for example but not limited to Penicillium digitatum and Penicillium italicum).

Preferably, the methods of the present disclosure are applicable against the genus Penicillium, preferably Penicillium digitatum and Penicillium italicum and against the genus Geotrichum, preferably Geotrichum candidum.

In other words, the present invention provides a method of prolonging the shelf life of agricultural food products, e.g., fruits and vegetables, such as citrus fruits, comprising applying to the food products an aqueous dispersion comprising very slightly water soluble or water-insoluble magnesium compounds, e.g., magnesium oxide, magnesium hydroxide or a mixture thereof and optionally at least one suspension aid (such as a phosphate-based dispersant), by immersing the food products in the dispersion or by spraying the dispersion onto the food products, wherein said method is for protecting harvested produce from decay by fungal infection and/or for controlling fungi on harvested produce, wherein said fungal infection is by at least one of Penicillium digitatum, Penicillium italicum and Geotrichum candidum and/or wherein said shelf life is extended by at least three days, five days seven days, two weeks, three weeks or four weeks, under storage in the refrigerator and/or at ambient temperature.

Prolonging the shelf life of agricultural food products, e.g., fruits and vegetables, using the suspension/dispersion of the present disclosure can be performed by applying the suspension/dispersion described herein using any method known in the art, manually or mechanically. For example, the food products can be subjected post-harvest (e.g. by dipping, or immersing) to a bath or a vessel of appropriate dimensions containing the suspension/dispersion, for a time period of between about 30 seconds to two minutes or more, while avoiding damage to the skin/peel of the food products. Alternatively, the suspension may be applied by spraying onto the agricultural food products, prior to or post-harvest, using appropriate sprayer and by adjusting the dispersion for a spray application as known in the art.

The method of prolonging the shelf life of agricultural food products (e.g., fruits and vegetables, such as citrus fruits) as herein defined may further comprise additional steps, further to the application of the suspension/dispersion as herein defined, for example addition of a waxing step. As known in the art, waxing is a process by which fruits (and in some cases also vegetables) are covered with artificial waxing material. The natural wax is first removed from the fruits or vegetables, usually by washing, followed by a coating of a biological or petroleum derived wax, primarily to prevent water loss and retard shrinkage and spoilage, and in addition for improving appearance. Thereby, storage life (shelf life) is extended. Waxing agents are commercially available and any waxing agent known in the art compatible for fruits and/or vegetable covering is encompassed by the present disclosure, for example as described below.

The method of prolonging the shelf life of agricultural food products such as fruits and vegetables as herein defined may further comprise a step of application of a fungicide to the agricultural food products, before, after or concomitantly with the application of the dispersion as herein defined.

The aqueous dispersion(s) as defined herein may be applied to the agricultural food products (e.g., fruits and vegetables) prior to harvesting, e.g., 1-2 days before harvesting, or at any time after harvesting, e.g., 1-10 days after harvesting. Application of the aqueous dispersion(s) as defined herein to the agricultural food products can be repeated.

It should be appreciated that the terms “fruit” and “fruits” are used interchangeably. It should also be appreciated that the terms “agricultural food products” and “agricultural produce” are used interchangeably and have a similar meaning.

The invention will be further described and illustrated by the following examples.

### EXAMPLES

### Materials Used for Preparing the Aqueous Dispersions in the Examples Below are Tabulated in Table 1:

TABLE 1
Materials

| COMPONENT | | |
|---|---|---|
| (MANUFACTURER) | GENERAL DESCRIPTION | FUNCTION |
| ZIVDAR Wax | Coating fresh citrus fruit with waxes | |
| (DECC Safepack Products | retards weight loss and shriveling and | |
| Ltd.) | affords an appealing appearance | |
| A phosphate-based dispersant | phosphate-based dispersant (“PBD”) | Dispersant |
| (Jost Chemicals) | | |
| TexFRon ® AG | Aluminum ammonium polyphosphate | Dispersant |
| (ICL-IP) | (also termed aluminum ammonium | |
| | superphosphate) | |
| Mono ammonium phosphate | Mono Ammonium Phosphate (MAP) | Dispersant |
| (ICL) | | |
| Magnesium Oxide (ICL-IP) | Magnesium oxide | Active agent |
| Mg(OH)₂ (ICL-IP) | Magnesium hydroxide | Active agent |
| Magnesium bicarbonate (ICL-IP) | Magnesium bicarbonate | Active agent |
| Xanthan (TNJ Chemicals) | Xanthan Organic stabilizer | Dispersant |
| Imazalil (Decco Safepack) | Enilconazole, 1-{2-(2,4- | Fungicide |
| | Dichlorophenyl)-2-[(prop-2-en-1- | |
| | yl)oxy]ethyl}-1H-imidazole | |
| TBZ (Decco Safepack) | Thiabendazole, (1-[2-(Allyoxy)-2- | Fungicide |
| | (2,4-dichlorophenyl)ethyl]-1H-) | |
| Polyoxin (Polar, Merhav | Polyoxin Aluminum 50% | Fungicide |
| Agro) | | |
| Guazatine (ICA international | Iminoctadine, C18H41N7 | Fungicide |
| CitriCure) | | |

### Methods

### Fungi

Penicillium digitatum, Penicillium italicum and Geotrichum candidum spores were obtained from the Israeli Agricultural Research Organization—Volcani Center.

### Citrus Trees Maintenance and Fruit Harvest

All citrus trees were routinely treated by irrigation and fertilization. Harvested fruit were stored at 5° C.-10° C.

### Fruit Infection/Inoculation

Generally, fruits were infected by inflicting two or three wounds to each fruit unit (at different sites of the fruit's skin) using a dissecting needle immersed in a suspension comprising the pathogenic agent (at a range of 1×10⁴-1×10⁷ spores/ml). In particular, white grapefruits were infected as detailed above by Penicillium digitatum suspension at a concentration of 1×10⁶ spores/ml, either 4 or 24 hours before being subjected to further treatment step and meanwhile stored at 5-10° C., covered by a plastic sheet. Mandarins (Or) were infected seven days post harvest as detailed above by Geotrichum candidum suspension at a concentration of 1×10⁷ spores/ml, 4 or 24 hours before being subjected to further treatment. Red grapefruits were infected with Penicillium digitatum or Penicillium italicum by inflicting two wounds to each one of the fruit units and inoculating the fungi into the wounds by dripping (20 μl of fungi at 5×10⁴ spores/ml), two hours after injury.

### Applying Aqueous Suspensions to the Fruits

Fruits were coated by suspensions by dipping the fruits, placed in a strainer-like vessel, for 30 seconds in a 20-liter vessel containing about 10 liters of the relevant suspension. The fruits were let to air-dry. At least 0.2 gr magnesium oxide were required for preparing suspensions per dipping of 1 kg fruit.

### Waxing

Waxing was performed by dipping the fruits, placed in a strainer-like vessel, in a vessel containing wax (ZIVDAR Wax, DECC Safepack Products Ltd.). Waxed fruits were dried by using a warm air tunnel (on a conveyor belt, residing about 60 seconds below a heater at about 40° C.). Where indicated, the waxing step was performed by dipping of the fruits in a vessel containing a solution/suspension comprising both the wax and the fungicide, at the indicated concentration.

### Application of Reference Fungicides

Generally, comparative (or reference) examples were generated by treating fruits with a solution or suspension comprising a known fungicide, specifically, unless indicated otherwise, by dipping of the fruits in a vessel containing a solution/suspension comprising the fungicidal agent at the indicated concentration, in wax. In particular, fruits were dipped in vessels containing an aqueous solution of imazalil (also termed chloramizole, enilconazole at 500 ppm), polyoxin A1 50% in water or in wax (also termed herein polar, at final concentrations of 1000, 2000, 3000 or 4000 ppm), guazatine in wax (1000-1500 ppm) or an aqueous solution of imazalil and TBZ (500 and 3 ppm, respectively). All solutions were prepared according to the manufacturer's instructions. The treated fruits were then let to air dry.

### Preparation 1

Aqueous dispersion of magnesium oxide (MgO)

### (A) Preparation of Magnesium Oxide

Magnesium Oxide was prepared as follows. Magnesium chloride (MgCl₂) solution at a concentration of 400-550 gr/l was roasted at a high temperature in a reactor (700-850° C.). Magnesium chloride was thereby decomposed to magnesium oxide (MgO) and hydrochloric acid (HCl). Magnesium oxide (MgO) was hydrated to magnesium hydroxide (Mg(OH)₂) at a temperature of 60-90° C. Magnesium hydroxide was washed from soluble salts and milled to the required particle size, and then fed to a high temperature (600 to 950° C.) kiln where magnesium hydroxide was decomposed to magnesium oxide and water.

The magnesium oxide obtained according to the process described above was milled in a dry milling system (Jet Mill or pin mill) operated within the range of between 2 and 4.5 atmospheres of dry air pressure and powder flow rate between 100 to 200 kg/hr. The milling machine “Jet Mill” was kept under slightly negative pressure (very close to zero pressure) in order to control particle size distribution, Loss on ignition (LOI) and surface area. Analytical results obtained for a MgO sample so obtained are provided in Table 2 below.

TABLE 2
Analytical results of MgO sample

| Test | Units | Specification | | Typical result |
|---|---|---|---|---|
| Assay as Magnesium oxide, MgO | % | 96-100.5 | | 99.7 |
| Free Alkali | ml | 2.0 | max | 0.54 |
| Acid insoluble HAc | % | 0.1 | max | 0.038 |
| Soluble Salts/Substances | mg | 2.0 | max | 1.5 |
| Chlorides as Cl | ppm | 1000 | max | 376 |
| Arsenic as As ICP | ppm | 1.5 | max | 0.6 |
| Calcium as CaO | % | 1.0 | max | 0.06 |
| Iron as Fe | ppm | 700 | max | 37 |
| Loss on Ignition | % | 4.0 | max | 0.6 |
| Lead as Pb ICP | ppm | 0.5 | max | 0.4 |
| Bulk Density (untapped) | g/cc | 0.25 | min | 0.32 |
| Particle Size: residue on 325 mesh (wet sieve) | % | 1.0 | max | 0.1 |

| | | | |
|---|---|---|---|
| Particle Size: residue on 100 mesh (wet sieve) | % | 0 | 0 |

MgO prepared as described is characterized by a d₁₀ lower than 1.5 microns (namely 10% of the particles are smaller than this size), by a d₅₀ ranging from 1.5 to 6.0 microns (namely 50% of the particles are smaller than this size), by a d₉₀ ranging from 8.0 to 45 microns (namely 90% of the particles are smaller than this size), by specific BET surface area above 5.0 m²/gr, by a citric acid activity (CAA 40) ranging from 25 to 200 seconds, by a Loss on Ignition (LOI) ranging from 0.2 to 4.0%, and by a bulk density (untapped) of not less than 0.25 gr/ml.

### (B) Dispersion of Magnesium Oxide in Water

Magnesium oxide (500 gr) was suspended in 9.5 kg water (tap, drinking water) using a high shear mixer (ULTRA-TURRAX T50, JANKE & KUNKEL, IKA-Labortechnik) to obtain a homogenous suspension of 5% MgO (all concentrations reported herein are by weight relative to the total weight of the suspension/dispersion unless indicated otherwise).

### Preparation 2

### Aqueous Dispersion of Magnesium Hydroxide (Mg(OH)₂)

### (A) Preparation of Magnesium Hydroxide

Magnesium hydroxide was prepared by the Aman process, which is thermal decomposition of magnesium chloride brine. The outcome was MgO of 85% purity. After hydration and classification, the magnesium hydroxide slurry is filtered and then milled and dried.

### (B) Dispersion of Magnesium Hydroxide in Water

Magnesium hydroxide (500 gr) was suspended in 9.5 kg water (tap, drinking water) using a high shear mixer to obtain a homogenous suspension of 5% Mg(OH)₂.

### Preparation 3

### Aqueous Dispersions of Magnesium Bicarbonate Having Mg++ Concentration of 1500 ppm

A solution of magnesium bicarbonate in water (drinking water) was prepared such that Mg²⁺ concentration was 1500 ppm. After application on the fruit and drying, magnesium bicarbonate converts to basic magnesium carbonate (BMC).

### Preparation 4

### Aqueous Dispersions of Phosphate-Based Dispersants

A phosphate-based dispersant (PBD, 200 gr or 250 gr) was dissolved in 9.8 kg or 9.75 kg tap water, respectively using a high shear mixer to obtain a homogenous suspension of 2% or 2.5%, respectively.

### Preparation 5

### Aqueous Dispersions of Magnesium Compounds and Suspension Aid(s)

In its most general form, preparing a dispersion comprising magnesium oxide, magnesium hydroxide or magnesium bicarbonate and a suspension aid (e.g., a dispersant such as a phosphate-based dispersant) was performed by first adding the relevant suspension aid (dispersant) to the magnesium powder and mixing well, the mixed powder is then added to water, to obtain the desired final concentrations of the magnesium compounds and suspension aid (dispersant) in the suspension. The suspension was mixed by high shear mixing, as detailed above.

Specifically, for preparing suspensions comprising MgO and a phosphate-based dispersant (PBD), 10 gr or 12.5 gr of PBD were added to MgO (500 gr), mixed and then added to water in a high shear mixer to obtain a homogenous suspension of 5% MgO by weight of the total weight of the dispersion and 2% or 2.5% PBD by weight of the MgO concentration, respectively (in other words, the suspension aid (dispersant, e.g., PBD) was present at a concentration of 0.1% or 0.125% by weight of the total weight of the dispersion). In addition, for preparing a suspension comprising MgO, PBD and aluminum ammonium polyphosphate (AG), aluminum ammonium polyphosphate (at 30 gr) and PBD (at 10 gr or 12.5 gr) were first mixed and added to magnesium oxide, magnesium hydroxide or magnesium bicarbonate (at 500 gr) while adjusting the water content of the suspension to a maximum of 10.0 kg.

A suspension comprising MgO and MAP was prepared by adding MAP (12.5 gr) to water (9.48 kg) and MgO (500 gr) in a high shear mixer to obtain a homogenous suspension of MgO at 5% of the total weight of the dispersion and MAP 2.5% of the MgO weight (namely MAP was at a concentration of 0.125% of the total weight of the dispersion).

### Preparation 6

### Aqueous Dispersions of Magnesium Compounds and Fungicide(s)

A suspension comprising MgO and polyoxin was prepared by Volcani agriculture R&D.

### Example 1

The Effect of Applying on Infected Grapefruits Magnesium Oxide, Alone or in Combination with a Phosphate-Based Dispersant, on Fruit Decay

In order to examine coating citrus fruits with aqueous dispersions containing magnesium oxide as means for post-harvesting product preservation, white grapefruits (210 fruit units) harvested at Nir Am were simultaneously wounded and inoculated with Penicillium digitatum shortly after harvesting, as detailed above, and then stored four (4) hours at 10° C. until further treatment.

Fruits were then divided into treatment groups numbered No. 1 to No. 7 as detailed in Table 3 below, each group including 10 fruit units in triplicates, such that the total number of fruit units in each tested group was 30. The various groups were subjected to treatment steps as detailed in Table 3 below.

TABLE 3
Treatment groups of white grapefruits harvested at
Nir Am and infected with Penicillium digitatum

| Treatment | |
|---|---|
| group No. | Treatment type |
| 1 | Control 1 - without coating/waxing |
| 2 | Control 2 - waxing only |
| 3 | Coating with an aqueous dispersion comprising MgO (5%) and PBD (0.1%), |
| | drying and waxing |
| 4 | Coating with an aqueous dispersion comprising MgO (5%) and PBD |
| | (0.125%), drying and waxing |
| 5 | Coating with an aqueous dispersion comprising PBD (2%), drying and |
| | waxing |
| 6 | Coating with an aqueous dispersion comprising PBD (2.5%), drying and |
| | waxing |
| 7 | Coating with an aqueous dispersion comprising MgO (5%), drying and |
| | waxing |

As evident from Table 3 above, fruits infected with Penicillium digitatum were either left untreated (“control 1”, group No. 1) or only subjected to a waxing step followed by drying (“control 2”, group No. 2). Waxing was performed as detailed above.

Alternatively, Penicillium digitatum-infected fruits were immersed (by dipping as detailed above) in various aqueous dispersions, comprising either MgO alone (at 5% by weight, group No. 7), or PBD (phosphate-based dispersant) alone (at 2% or 2.5% by weight, groups No. 5 or 6, respectively). In addition, two treatment groups were immersed in aqueous dispersions comprising both MgO and PBD (group No. 3 or group No. 4). After the coating step, fruits were dried and subjected to a waxing step, performed as detailed above. Preparation and composition of the aqueous dispersions used are detailed above.

After treatment, fruits were kept at 10° C. and monitored for the presence of decay at the inoculated sites after 7 and 14 days of storage. After being stored in the cold (10° C.), fruits were kept at a temperature of 20° C., simulating ambient storage conditions, and monitored for the development of decay, as detailed below.

Decay was determined based on appearance of discoloration spots on the fruit skin (white, green or blue) which are typical to molds. Fruits showing at least one discoloration spot were considered to be inedible and contributed to the decay percentage calculated based on the total number of fruits in the treatment group.

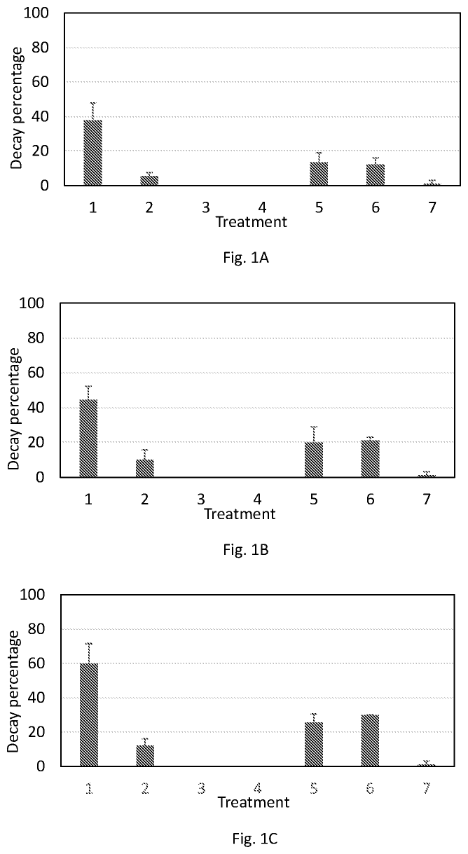

The results of the above study, presented in FIG. 1A, FIGS. 1B and 1n FIG. 1C, show that treatments including coating the infected fruits with dispersions containing MgO alone or in combination with PBD were the most effective in preventing infection and decay development. The level of inhibition in the effective treatments was almost 100%. Dispersions comprising PBD per se, at both concentrations tested, exhibited reduced effect against P. digitatum compared to a dispersion comprising MgO per se.

In particular, FIG. 1A shows the decay percentage of treated fruit groups No. 1-7 after two-week storage at 10° C. As shown in FIG. 1A, in the absence of any treatment, the decay percentage was about 40%, meaning that 40% of the fruits were not suitable for eating. Waxing per se reduced the decay percentage to about 10%. Remarkably, decay was almost completely inhibited when the fruits were treated with a dispersion comprising MgO alone (group No. 7) or in combination with PBD (groups No. 3 and 4). Treatment of infected groups with a dispersion comprising PBD alone modestly inhibited the decay (groups No. 5 and 6).

As detailed above, fruits immersed in aqueous dispersions were also subjected to waxing. Remarkably, however, in control group No. 2, treated by waxing only, the decay percentage was lower than that shown for treatment groups No. 5 and No. 6, which were coated with a dispersion comprising PBD in addition to waxing. Without wishing to be bound by any theory, these results indicate that PBD does not contribute to fruit decay when administered alone. However, PBD assists in dispersing the MgO, resulting in little settling of MgO in the dispersions prepared and therefore addition thereof is beneficial.

Similar effects were observed for the various treatment groups upon a further incubation period, as shown in FIGS. 1B and 1n FIG. 1C, demonstrating the decay levels (percentages) in the various treatment groups after an incubation period of 14 days at 10° C. and further incubation of two or five days at 20° C., respectively.

Appearance of fruits of each one of the above treatment groups (namely group No. 1 to group No. 7) stored at 10° C. for two weeks and then at 20° C. for five days are shown in FIG. 2A to FIG. 2G, respectively. The superiority of the combined treatment by the aqueous dispersion comprising both MgO and PBD is evident from the fruit appearance in FIG. 2C and in FIG. 2D, corresponding to treatment groups No. 3 and No. 4, respectively, showing that PBD contributes to fruit preservation post infection.

### Example 2

### The Effect of Applying on Infected Grapefruits Magnesium Oxide, a Phosphate-Based Dispersant and Additional Phosphate Salts, on Fruit Decay

Next, white grapefruits (harvested at Nir Am) were simultaneously wounded and infected by Penicillium digitatum as detailed above, 4 or 24 hours before the application of treatment, to examine the effect of a delay in treatment on the fruit decay pattern. Infected fruits were stored (covered) at 10° C. until being further treated.

In addition, the effect of including alternative/additional phosphate salts in the MgO dispersions as well as the effect of including a waxing step in the treatment were examined.

To this end, infected fruits were divided into treatment groups as detailed in Table 4 below, each including 10 fruit units, in triplicates. Specifically, groups No. 1A to No. 6A were infected 4 hours prior to treatment, while groups No. 1B to No. 6B were infected 24 hours prior to treatment. Treatment groups No. 7 and No. 8 were infected four hours prior to treatment.

TABLE 4
Treatment groups of white grapefruits harvested at
Nir Am and infected with Penicillium digitatum

| | Infection | |
|---|---|---|
| | time prior | |
| Treatment | to treatment | |
| group No. | (hours) | Treatment type |
| 1A | 4 | Control - without coating/waxing |
| 1B | 24 | |
| 2A | 4 | Control - waxing only |
| 2B | 24 | |
| 3A | 4 | Coating with an aqueous dispersion comprising MgO (5%) and |
| 3B | 24 | PBD (0.125%), followed by drying |
| 4A | 4 | Coating with an aqueous dispersion comprising MgO (5%) and |
| 4B | 24 | PBD (0.125%), drying and waxing |
| 5A | 4 | Coating with an aqueous dispersion comprising MgO (5%), |
| 5B | 24 | PBD (0.125%) and AG (0.3%), followed by drying |
| 6A | 4 | Coating with an aqueous dispersion comprising MgO (5%), |
| 6B | 24 | PBD (0.125%) and AG (0.3%), drying and waxing |
| 7 | 4 | Coating with an aqueous dispersion comprising MgO (5%) and |
| | | MAP (0.125%), follwed by drying |
| 8 | 4 | Coating with an aqueous dispersion comprising MgO (5%) and |
| | | MAP (0.125%), drying and waxing |

As detailed in Table 4 above, the treatment program of the various groups was as follows. Penicillium digitatum-infected fruits were either left un-treated (groups No. 1A and No. 1B in Table 4) or only subjected to a waxing step (groups No. 2A and No. 2B in Table 4).

In addition, treatment groups No. 3A, 3B, 4A, 4B were immersed four hours (groups No. 3A and 4A) or 24 hours (groups No. 3B and 4B) post-infection in aqueous dispersions comprising MgO and PBD, where treatment groups No. 4A and 4B were also subjected to a waxing step. In a similar fashion, treatment groups No. 5A, 5B, 6A and 6B were immersed in an aqueous dispersion comprising MgO, PBD and aluminum ammonium polyphosphate (AG). Treatment groups No. 7 and 8 were immersed in an aqueous dispersion comprising MgO and mono ammonium phosphate (MAP). All aqueous dispersions were prepared as described above.

Treatment groups (including the control group) were stored for two weeks (14 days) in a storage room having a temperature of 10° C., and then moved to 20° C. for seven (7) days, during which they were examined for decay.

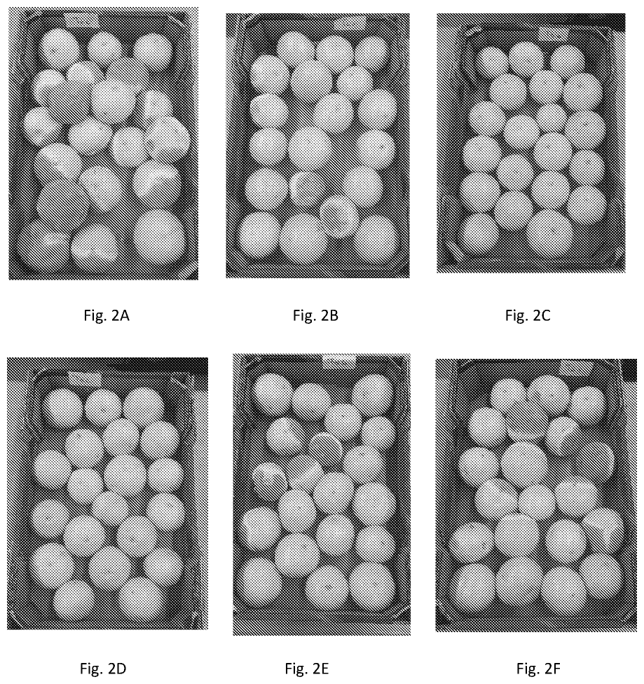

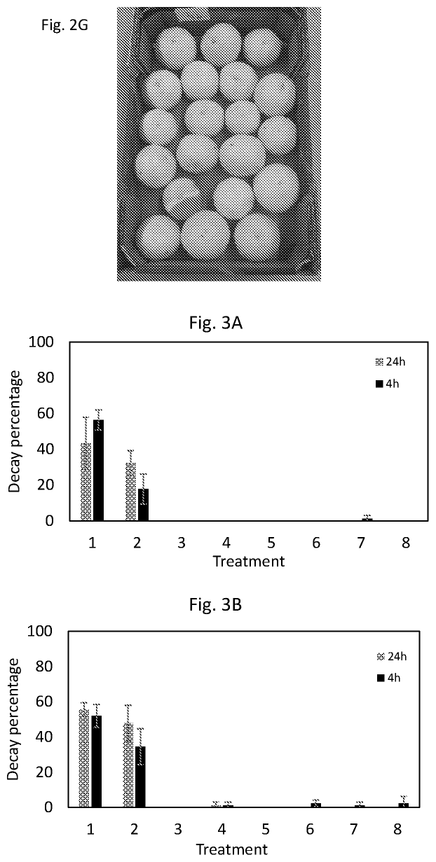

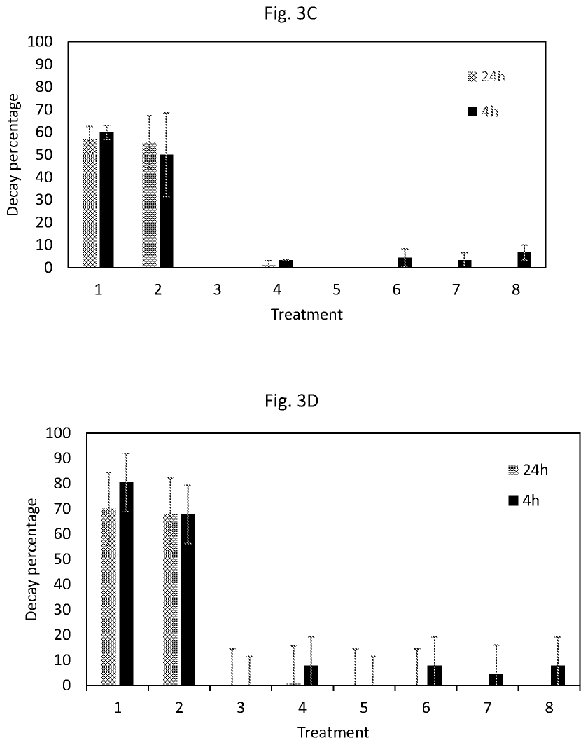

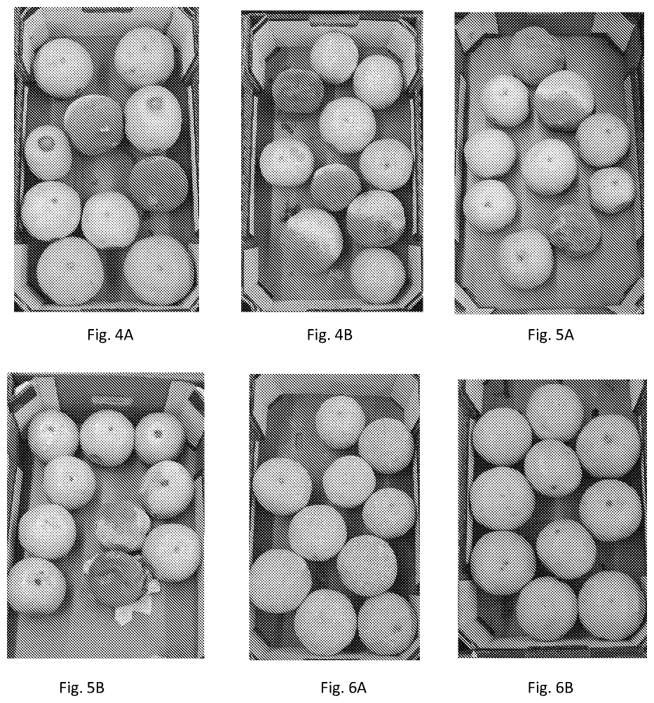

The results of this experiment show that treatment with dispersions including MgO in combination with PBD or MAP were very effective in inhibiting infection and decay development, regardless of the time of inoculation relative to treatment start. Surprisingly, the time of inoculation did not affect the efficacy of treatment in inhibiting decay development after the storage period, as treatment was slightly more effective when inoculation was performed 24 hours before treatment start. The results are shown in FIG. 3A, FIG. 3B, FIG. 3C and in FIG. 3D which respectively show the decay percentage in the treated fruit groups after two weeks in a storage room having a temperature of 10° C. and further zero, two, five or seven days at 20° C.

Furthermore, as shown in FIG. 3D, in the control groups (namely waxed and non-waxed fruit), decay incidence was approximately 70% compared to almost 0% in all of the other treatment groups which were based on dispersions comprising combinations of MgO and additional additives. Although in fruits inoculated 4 hours before the application of MgO-based treatment, the incidence of green mold was slightly higher, it was markedly lower than that recorded in the controls.

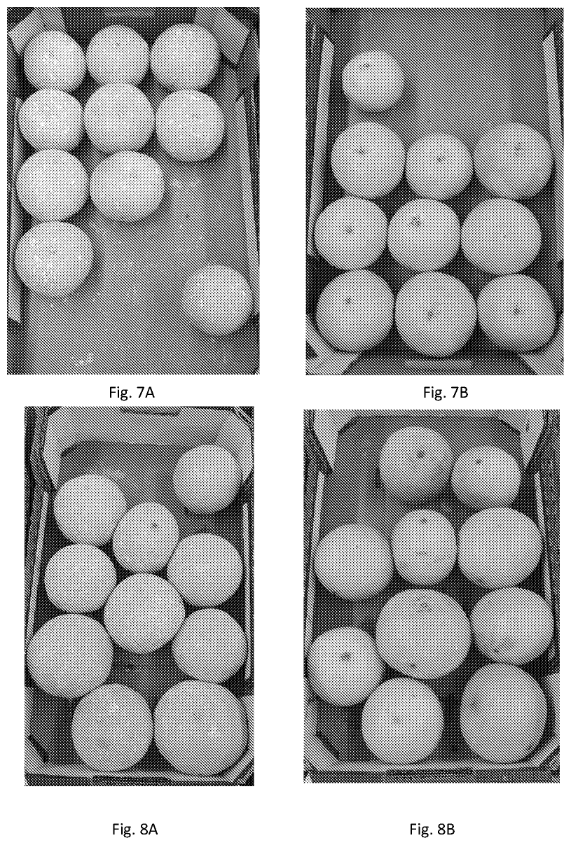

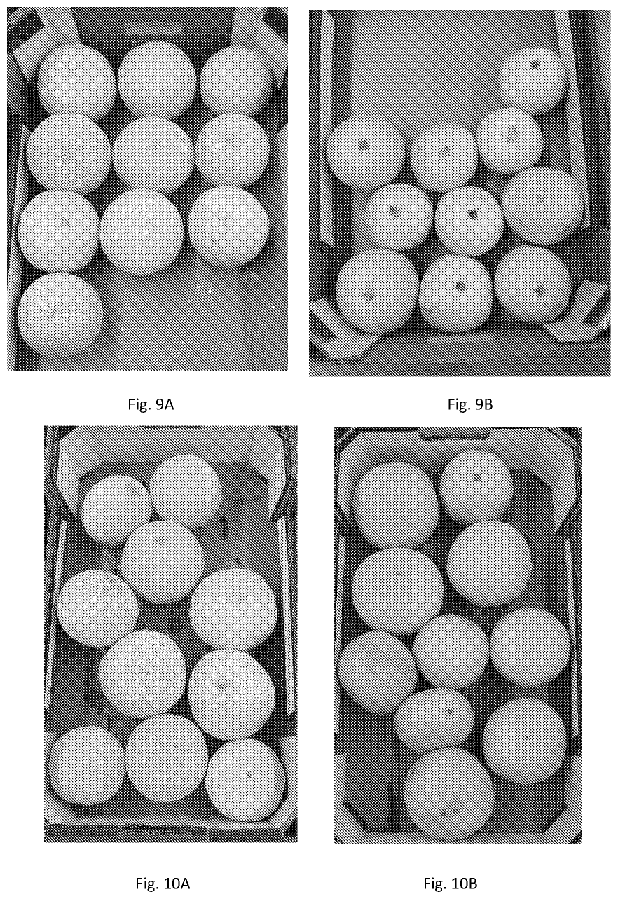

Visual presentation of the effects of treatment on decay development in infected grapefruits after two weeks (14 days) at 10° C. and seven days at 20° C. are shown in FIG. 4 through FIG. 10.

As shown in these figures, for each one of the treatment groups, regardless of whether the infection was performed 4 or 24 hours prior to treatment start, the waxing step had an effect on fruit appearance. For example, FIG. 6B is a photograph showing treatment group No. 4A, namely of fruits infected with Penicillium digitatum 4 hours before coating with an aqueous dispersion comprising 5% MgO and 0.125% PBD. As apparent from FIG. 6B, all fruit units have a fresh appearance. In contrast, FIG. 6A, a photograph showing treatment group No. 3A, in which the fruits were coated with the same aqueous dispersion as that used for group No. 4A, but were not subjected to a waxing step, shows a white powder covering the fruits, arising from the presence of fine magnesium particles on the fruit skin.

### Example 3

### The Effect of Washing the Grapefruits Treated by MgO Dispersions on Fruit Decay

Further to the above results, the inventors examined whether washing the fruits immediately after the coating step had an effect on the protective properties of the dispersions comprising MgO, PBD or combinations thereof.

To this end, white grapefruits (300 units, harvested at the Shadmot Mehola) were simultaneously wounded and infected by Penicillium digitatum as detailed above. The infected fruits were treated 4 hours post-infection, as detailed in Table 5 below, and then stored 9 days at 10° C., then removed to storage at 20° C. and examined for decay after zero (0), 3, 5 and 7 days at 20° C.

TABLE 5
Treatment groups of white grapefruits harvested at Shadmot
Mehola and infected with Penicillium digitatum

| Treatment | |
|---|---|
| group No. | Treatment type |
| 1 | Control 1 - without coating/waxing |
| 2 | Control 2 - waxing only |
| 3 | Coating with an aqueous dispersion comprising MgO (5%) |
| | and drying |
| 4 | Coating with an aqueous dispersion comprising MgO (5%), |
| | drying and waxing |
| 5 | Coating with an aqueous dispersion comprising PBD (2.5%) |
| | and drying |
| 6 | Coating with an aqueous dispersion comprising PBD (2.5%), |
| | drying and waxing |
| 7 | Coating with an aqueous dispersion comprising MgO (5%) |
| | and PBD (0.125%) and drying |
| 8 | Coating with an aqueous dispersion comprising MgO (5%) |
| | and PBD (0.125%), drying and waxing |
| 9 | Coating with an aqueous dispersion comprising MgO (5%) |
| | and PBD (0.125%), drying and washing |
| 10 | Coating with an aqueous dispersion comprising MgO (5%) |
| | and PBD (0.125%), drying, washing and waxing |

As described in Table 5 above, treated fruit groups No. 1 and 2 were control groups in which group No. 2 was only subjected to a waxing step. All other treated fruit groups were subjected to treatments comprising, among others, coating by dispersions comprising the agents listed in Table 5 and prepared as detailed above, drying, with or without a waxing step.

Briefly, treated fruit groups No. 3 and 4 were coated with an aqueous dispersion comprising MgO (5%) and dried, in the absence and in the presence of a waxing step, respectively and treated fruit groups No. 5 and 6 were coated with an aqueous dispersion comprising PBD (2.5%) and dried, in the absence and in the presence of a waxing step, respectively.

Treated fruit groups No. 7-No. 10 were subjected to treatment comprising coating with a dispersion comprising a combination of MgO and PBD, either without a waxing step (treated fruit groups No. 7 and 9) or with a waxing step (treated fruit groups No. 8 and 10). However, in treated fruit groups No. 9 and No. 10 the steps of coating by the dispersion and drying was immediately followed by a washing step with tap water. All of the dispersions were prepared as described above.

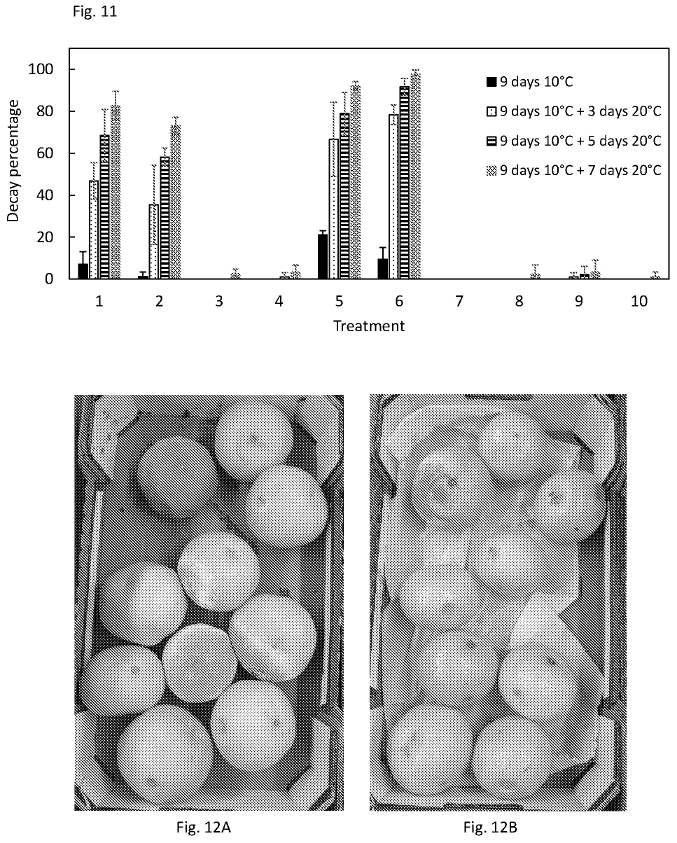

As shown in FIG. 11, there was no effect for a dispersion comprising PBD per se on controlling decay incidence. The level of decay (decay percentage) after the storage period (i.e., nine days at 10° C. and zero to seven days at 20° C.) was similar to that in the control treatments.

In contrast, in the treatment groups that included coating with a dispersion comprising MgO alone, the decay percentage was effectively controlled, however, slightly below the effect level of a dispersion comprising MgO combined with PBD which was especially noted after nine days at 10° C. and seven days at 20° C.

Remarkably, adding a washing step after coating the fruits with the dispersion did not affect the efficacy of the treatment. After washing, the fruits appeared to be cleaner from MgO residues. Without wishing to be bound by theory this observation implies that the aqueous dispersion is rapidly absorbed in the fruit skin pores.

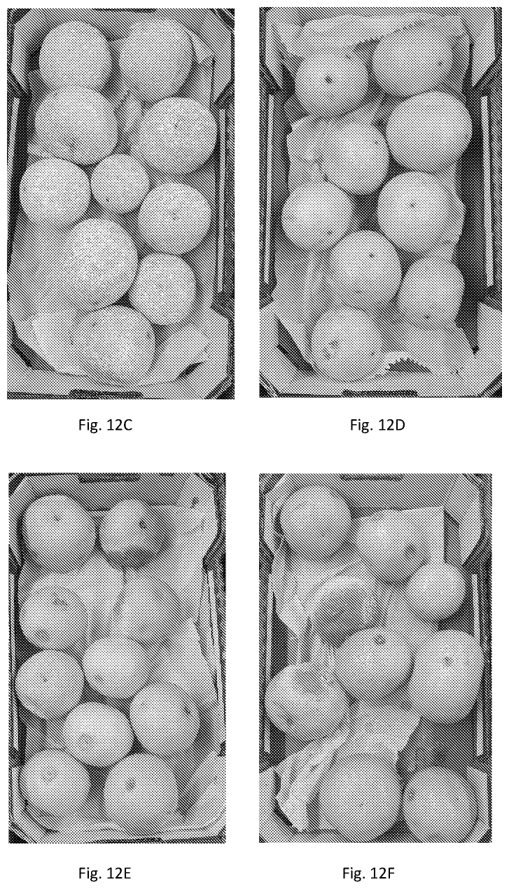

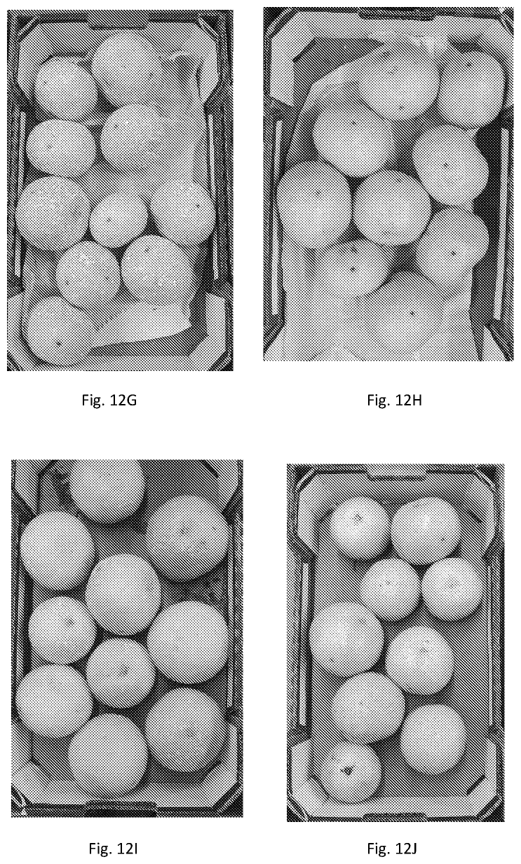

FIG. 12 shows photographs of fruit appearance under the different treatments described in the present example, after nine days of storage at 10° C. and five (5) days storage at 20° C. The effect of waxing is demonstrated in FIG. 12C, in which dried MgO is shown as a white powder on the fruits presented in the figure, as opposed to fruit appearance in FIG. 12D (showing fruits that were subject to a waxing step).

### Example 4

The Effect of Applying Mg(or Mg(OH)₂ on Red Grapefruits Infected with Penicillium Digitatum, on Fruit Decay

Next, the effect of coating citrus fruit with dispersions comprising either MgO or Mg(OH)₂ was tested on wounded red grapefruits inoculated with the fungi Penicillium digitatum.

To this end, red grapefruits (180 units) were harvested, wounded by inflicting two wounds and after two hours inoculated with fungal spore suspension (20 μl of a 5×10⁴ culture). The fruits were then divided into treatment groups (each group including 15 fruit units, in duplicates) as detailed in Table 6 below. Briefly, the various treatment groups of infected fruits were coated with the dispersions detailed below, stored 12 days at 7° C. and then moved to storage at 20° C. for up to 14 days. Decay in the fruit was evaluated as detailed above after zero (0), 5 and 7 and 14 days at 20° C.

TABLE 6
Treatment groups of red grapefruits infected
with Penicillium disitatum

| Treatment | |
|---|---|
| group No. | Treatment type |
| 1 | Dipping in water (control) |
| 2 | Coating with an aqueous dispersion comprising MgO (5%) |
| 3 | Coating with an aqueous dispersion comprising MgO (5%) |
| | and Xanthan gum (0.1%) |
| 4 | Coating with an aqueous dispersion comprising MgO (5%) |
| | and PBD (0.1%) |
| 5 | Coating with an aqueous dispersion comprising Mg(OH)₂ |
| | (5%) and Xanthan gum (0.1%) |
| 6 | Coating with an aqueous dispersion comprising Mg(OH)₂ |
| | (5%) and PBD (0.1%) |

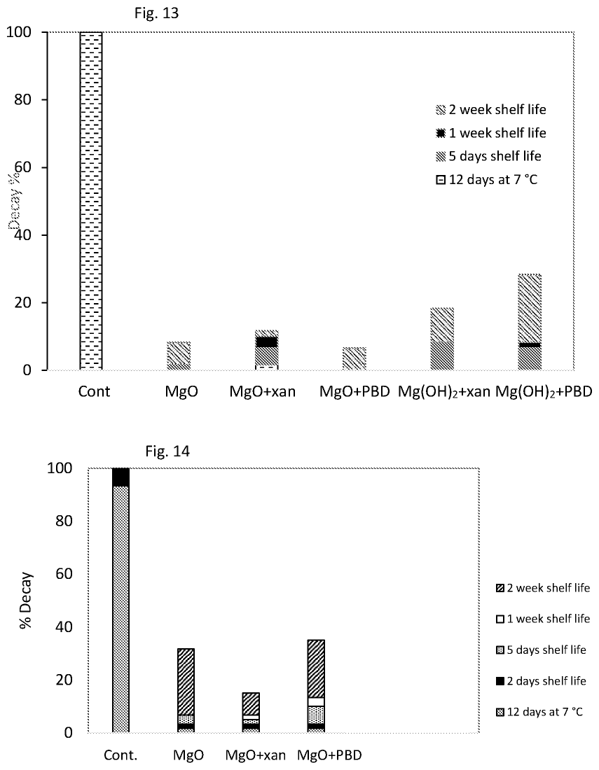

FIG. 13 presents the effects of MgO and Mg(OH)₂ dispersions on development of green molds and consequently the decay percentage in infected red grapefruits. As shown in FIG. 13, in the control group (namely in the absence of coating), decay reached 100%. However, decay was greatly decreased when the fruits were coated by the various dispersions detailed in Table 6 above, in particular with a dispersion comprising MgO alone (group No. 2 above) or with a dispersion comprising MgO in combination with PBD (group No. 4 above).

### Example 5

The Effect of Applying MgO on Red Grapefruits Infected with Penicillium italicum, on Fruit Decay

The effect of coating citrus fruit with dispersions comprising MgO was next tested on wounded red grapefruits inoculated with the fungi Penicillium italicum.

Red grapefruits were harvested and infected by Penicillium italicum by inflicting two wounds to the fruit skin and after two hours inoculating the wounds with fungal spore suspension (20 μl of a 5×10⁴ culture). The fruits were then divided into treatment groups (each group including 15 fruit units, in duplicates) as detailed in Table 7 below.

Briefly, the various treatment groups of infected fruits were coated with the dispersions detailed below, stored 12 days at 7° C. and then moved to storage at 20° C. for up to two weeks (14 days). Decay in the fruits was evaluated as detailed above, after zero (0), 2, 5, 7 and 14 days at 20° C., as detailed below.

TABLE 7
Treatment groups of red grapefruits
infected with Penicillium italicum

| Treatment | |
|---|---|
| group No. | Treatment type |
| 1 | Dipping in water (control) |
| 2 | Coating with an aqueous dispersion comprising MgO (5%) |
| 3 | Coating with an aqueous dispersion comprising MgO (5%) |
| | and Xanthan gum (0.1%) |
| 4 | Coating with an aqueous dispersion comprising MgO (5%) |
| | and PBD (0.1%) |

FIG. 14 presents the effects of MgO dispersions on the development of blue molds and consequently the decay percentage in infected red grapefruits. As shown in FIG. 14, in the control group (namely in the absence of coating) decay reached over 80% after storage of 12 days at 7° C. and 2 days at 20° C. However, decay was greatly decreased when the fruits were coated by dispersions comprising MgO, when MgO was present in the dispersion alone or in combination with PBD or Xanthan.

### Example 6

### The Effect of Applying MgO or Mg(OH)₂ on Wounded Red Grapefruits, on Fruit Decay

Next, the effect of coating citrus fruit with dispersions comprising either MgO or Mg(OH)₂ was tested on red grapefruits inflicted with wounds, without inoculating the injured fruits with fungi. In this example, red grapefruits were harvested, wounded by inflicting two wounds thereto and divided into treatment groups (each group including 15 fruit units, in duplicates) as detailed in Table 8 below. Briefly, the various treatment groups of wounded fruits were coated with the dispersions detailed below, stored 12 days at 7° C. and then moved to storage at 20° C. for two weeks. Decay in the fruits was evaluated as detailed above after zero (0), 2, 5 and 7 and 14 days at 20° C.

TABLE 8
Treatment groups of wounded red grapefruits

| Treatment | |
|---|---|
| group No. | Treatment type |
| 1 | Dipping in water (control) |
| 2 | Coating with an aqueous dispersion comprising MgO (5%) |
| 3 | Costing with an aqueous dispersion comprising MgO (5%) |
| | and Xanthan gum (0.1%) |
| 4 | Coating with an aqueous dispersion comprising MgO (5%) |
| | and PBD (0.1%) |
| 5 | Coating with an aqueous dispersion comprising Mg(OH)₂ |
| | (5%) and Xanthan gum (0.1%) |
| 6 | Coating with an aqueous dispersion comprising Mg(OH)₂ |
| | (5%) and PBD (0.1%) |

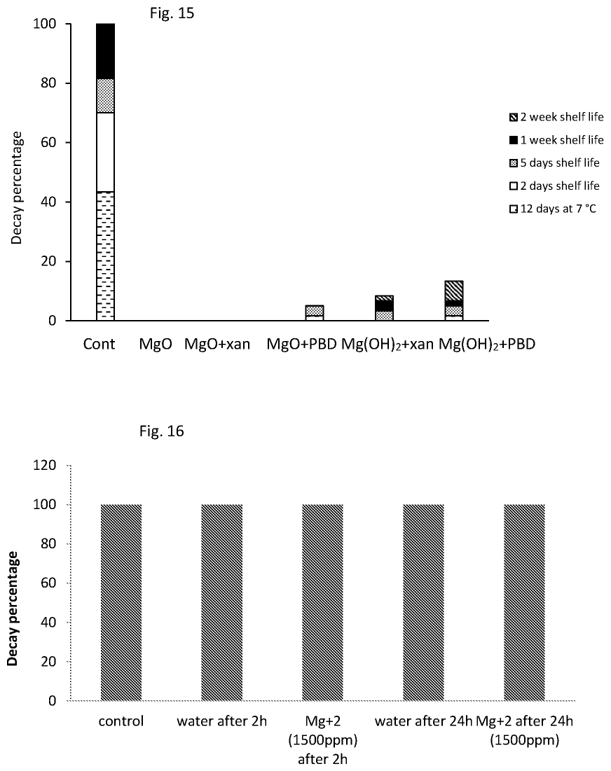

FIG. 15 presents the effects of MgO and Mg(OH)₂ dispersions on the development of molds and consequently the decay percentage in wounded red grapefruits. As shown in FIG. 15, decay reached 100% after storage of 12 days at 7° C. and 7 days at 20° C. in the control group (namely in the absence of coating). However, decay was greatly decreased when the fruits were coated by dispersions comprising MgO or Mg(OH)₂ alone or in combination with the additives (namely either PBD or Xanthan) detailed in Table 8 above.

### Example 7 (Reference Example)

### The Effect of Applying Magnesium Bicarbonate on Infected Oranges, on Fruit Decay

Further to the above results obtained with MgO and Mg(OH); dispersions, the effect of applying onto citrus fruits a solution comprising magnesium bicarbonate (Mg(HCO₃)₂) was examined, on wounded oranges inoculated with the fungi Penicillium digitatum.

Magnesium bicarbonate was dissolved in water, as described above. Harvested oranges were wounded and inoculated with Penicillium digitatum (20 μl of 1×10⁵ culture) and divided into treatment groups (each group including 15 fruit units), as detailed in Table 9 below. Briefly, the various treatment groups of infected fruits were coated with water or with a solution comprising magnesium bicarbonate as detailed below, stored at 20° C. and monitored for decay after two or 24 hours.

TABLE 9
Treatment groups of Penicillium digitatum infected oranges

| Treatment | |
|---|---|
| group No. | Treatment type |
| 1 | Control |
| 2 | Dipping in water (control) |
| 3 | Coating with an aqueous dispersion comprising |
| | magnesium bicarbonate (Mg²⁺, 1500 ppm) |

FIG. 16 presents the effects of a solution comprising magnesium bicarbonate on the development of molds and consequently the decay percentage in Penicillium digitatum oranges. As shown in FIG. 16, in the control group (in the absence of any coating), in the presence of water or in the presence of a solution comprising magnesium bicarbonate decay reached 100% after storage of two or 24 hours at 20° C.

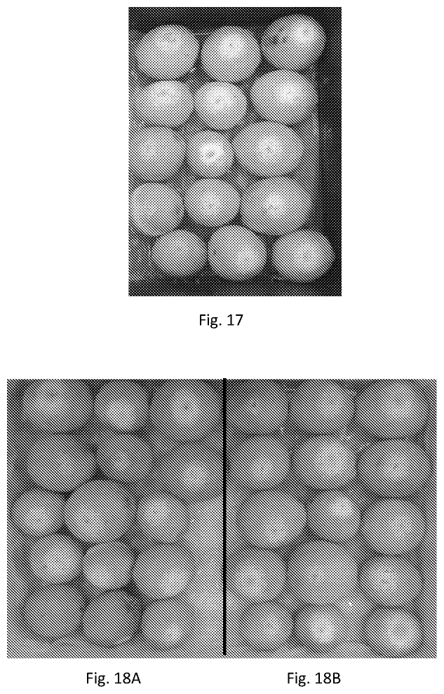

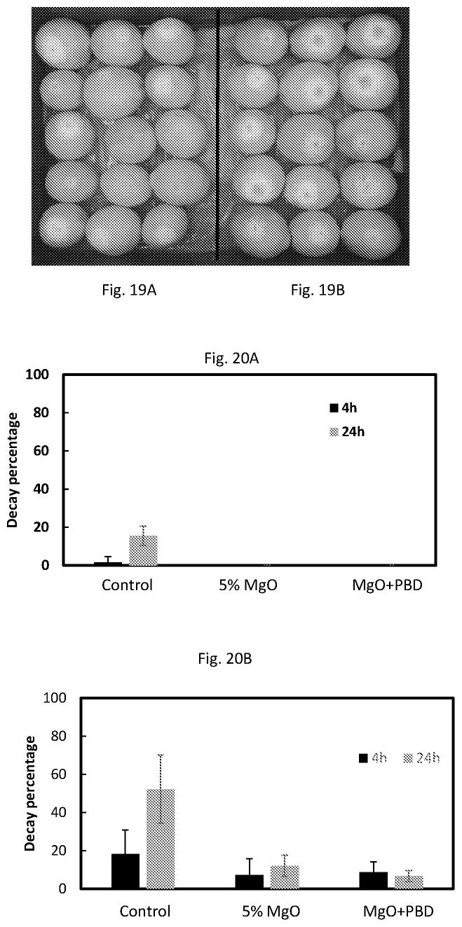

The effect of the solution comprising magnesium bicarbonate on decay is further demonstrated in FIGS. 17 to 19, where clear spoilage is evident already after two hours of storage at 20° C.

These results show that magnesium bicarbonate, which is converted to basic magnesium carbonate upon drying on the fruits (at a temperature of about 30-40° C.) and without wishing to be bound by theory, magnesium ions, do not contribute to preventing decay in Penicillium digitatum-infected fruits.

### Example 8

The Effect of Applying on Oranges and Mandarins Infected with G. candidum Magnesium Oxide, Alone or in Combination with a Phosphate-Based Dispersant, on Fruit Decay

Further to the above experimental results, the inventors have also tested the effect of applying a dispersion comprising MgO or a dispersion comprising a combination of MgO and PBD on mandarins (320 units of Or mandarins) infected with Geotrichum candidum

The fungal species G. candidum is the causative agent of the plant disease termed “sour rot”, and infects citrus fruits, tomatoes, carrots, and other vegetables. Mandarins were infected with G. candidum either four (4) or 24 hours prior to the application of the dispersions, as described above. Application of the dispersions followed (8 days after harvest), as detailed in Table 10 below, where each treatment group included three repeats of 10 fruit units each. After application of the dispersions, the fruits were further dried and waxed, by methods as described above. Immediately thereafter, the fruits were stored at 20° C. and decay level was monitored after 4, 6, 8, 11 and 14 days.

TABLE 10
Treatment groups of mandarins infected with G. candidum

| | Infection | |
|---|---|---|
| | time prior | |
| Treatment | to treatment | |
| group No. | (hours) | Treatment type |
| 1 | 4 | Control - waxing only |
| 2 | 24 | Control - waxing only |
| 3 | 4 | Coating with an aqueous dispersion |
| | | comprising MgO (5%), drying and waxing |
| 4 | 24 | Coating with an aqueous dispersion |
| | | comprising MgO (5%), drying and waxing |
| 5 | 4 | Coating with an aqueous dispersion |
| | | comprising MgO (5%) and PBD (0.125%), |
| | | drying and waxing |
| 6 | 24 | Coating with an aqueous dispersion |
| | | comprising MgO (5%) and PBD (0.125%), |
| | | drying and waxing |

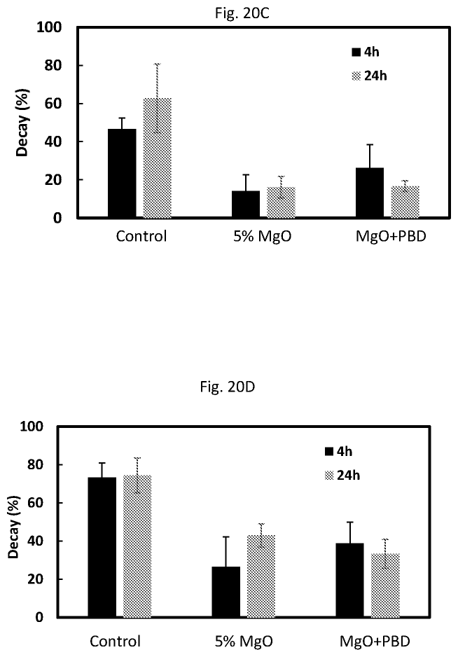

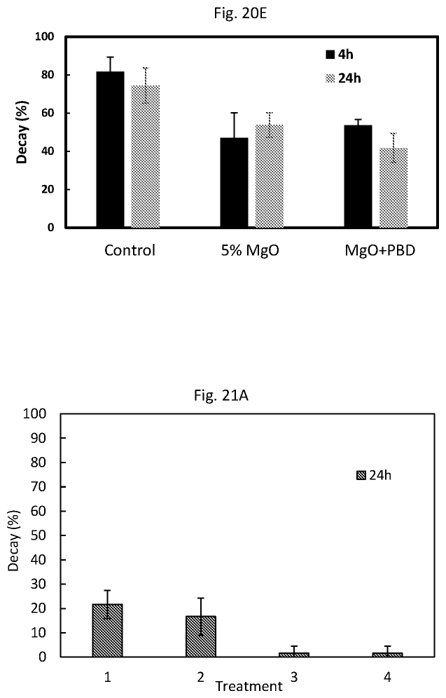

FIG. 20A through FIG. 20E show the decay level in infected mandarins treated as detailed above, after storage periods of 4, 6, 8, 11 and 14 days at 20° C., respectively. As demonstrated in these Figures, application of a dispersion comprising MgO alone or a dispersion comprising both MgO and PBD had generally a similar inhibitory effect on fruit decay.

Interestingly, in the control mandarins a decay percentage of about 50% was already present after six days of storage, as shown in FIG. 20B. Under such conditions, the inhibitory effect on decay contributed by dispersions comprising either MgO alone or MgO/PBD were pronounced, reducing the decay level by up to 5 fold after six storage days (FIG. 20B) and by about two fold after 11 or 14 days of storage (FIG. 20D and FIG. 20E respectively).

### Example 9

Comparing the Effect of Magnesium Oxide, in Combination with PBD, to the Effect of Imazalil on Decay of Infected Oranges

The effect of applying on infected fruits a dispersion comprising MgO and PBD (at 5% and 0.125%, respectively, by weight of the total weight of the dispersion) was next compared to the effect of applying on infected fruits the fungicide imazalil.

To this end, oranges (harvested at Nitzanim) were simultaneously wounded and infected by Penicillium digitatum as detailed above, 24 hours before the application of treatment and stored meanwhile at a temperature of 5° C. The infected fruits were next divided into treatment groups as detailed in Table 11 below, each including 10 fruit units, in triplicates.

TABLE 11
Treatment groups of oranges harvested at Nitzanim
and infected with Penicillium digitatum

| Treatment | |
|---|---|
| group | Treatment type |
| 1 | Control - waxing only |
| 2 | Control - washing in water and waxing |
| 3 | Coating with an aqueous dispersion comprising MgO (5%) |
| | and PBD (0.125%), followed by drying and waxing |
| 4 | Coating with a solution comprising imazalil (500 ppm) |
| | and waxing |

As detailed in Table 11 above, the treatment program of the various groups was as follows. After the infection (24 hours), fruits were either waxed only (group No. 1) or subjected to a waxing step after washing the fruits with water (group No. 2).

Fruits in treatment group No. 3 were immersed in an aqueous dispersion comprising MgO and PBD, as detailed above. Finally, fruits in treatment group No. 4 were subjected to coating by imazalil and a waxing step.

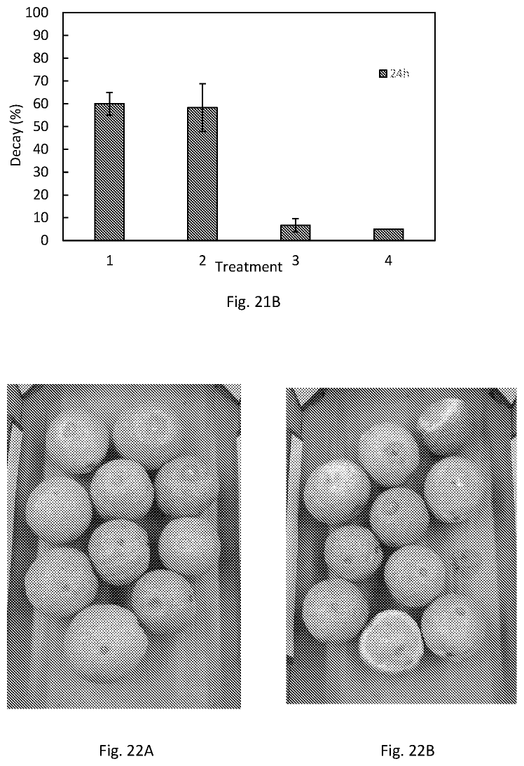

All of the fruit groups (including the controls) were stored for 11 days in a storage room having a temperature of 5° C. and then moved to 20° C. and the decay thereof was monitored after zero days at 20° C. (namely immediately after storage at 5° C.) as shown in FIG. 21A and after further nine days at 20° C., as shown in FIG. 21B.

The results of this experiment show the decay level in fruits immediately after storage at 5° C. (namely zero days at 20° C., FIG. 21A) and after further nine days at 20° C. (FIG. 21B). As shown in these figures, treatment with dispersions including MgO in combination with PBD were comparably effective to the effect of imazalil in inhibiting infection and decay development.

Fruit appearance post treatment, namely after 11 days at 5° C. and nine days at 20° C. for the various tested fruit groups is shown in FIG. 22A through 22D.

### Example 10

Comparing the Effect of Magnesium Oxide, in Combination with PBD, to the Effect of Polyoxin (Polar) on Decay of Infected Lemons

The effect of applying on infected fruits a dispersion comprising MgO and PBD (at 5% and 0.125%, respectively, by weight of the total weight of the dispersion) was next compared to the effect of applying on infected fruits the fungicide Polyoxin (interchangeably termed herein “polar”).

To this end, lemons were infected by Geotrichum candidum as detailed above, 24 hours before the application of treatment and stored meanwhile at a temperature of 5° C. The infected fruits were next divided into treatment groups as detailed in Table 12 below, each group including 20-40 fruit units, in quadruplicates.

TABLE 12
Treatment groups of lemons infected with Geotrichum candidum

| Treatment | |
|---|---|
| group | Treatment type |
| 1 | Control - waxing only |
| 2 | Coating with an aqueous dispersion comprising MgO (5%) |
| | and PBD (0.125%), followed by waxing |
| 3 | Coating with a solution comprising polar in wax (1000 |
| | ppm) |
| 4 | Coating with a solution comprising polar in wax (2000 |
| | ppm) |

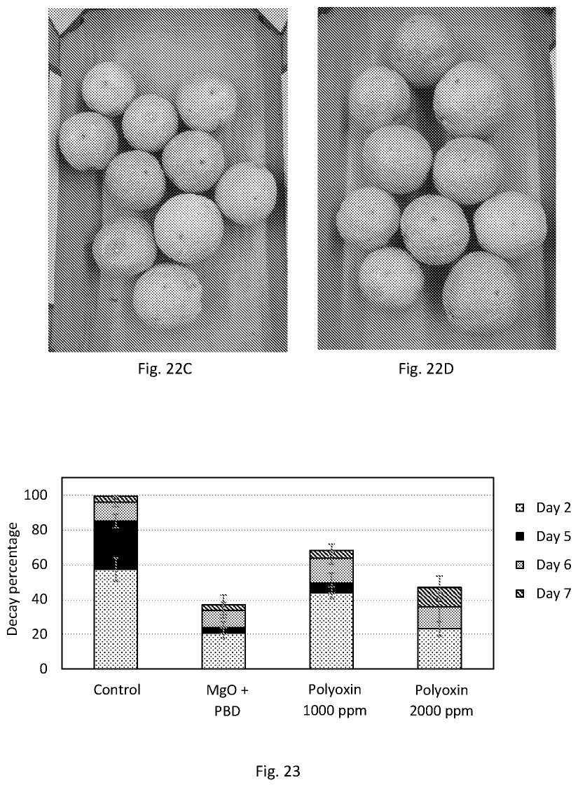

As detailed in Table 12 above, the treatment program of the various groups was as follows. After the infection (24 hours), fruits were either waxed only (group No. 1) or coated by an aqueous dispersion comprising MgO and PBD, as detailed above and then waxed (group No. 2). Fruits in treatment group No. 3 and No. 4 were subjected to coating by Polyoxin in wax (at 1000 or 2000 ppm, respectively). All of the fruit groups were then stored at 20° C. and the decay thereof was monitored after 2, 5, 6 or 7 days, as shown in FIG. 23.

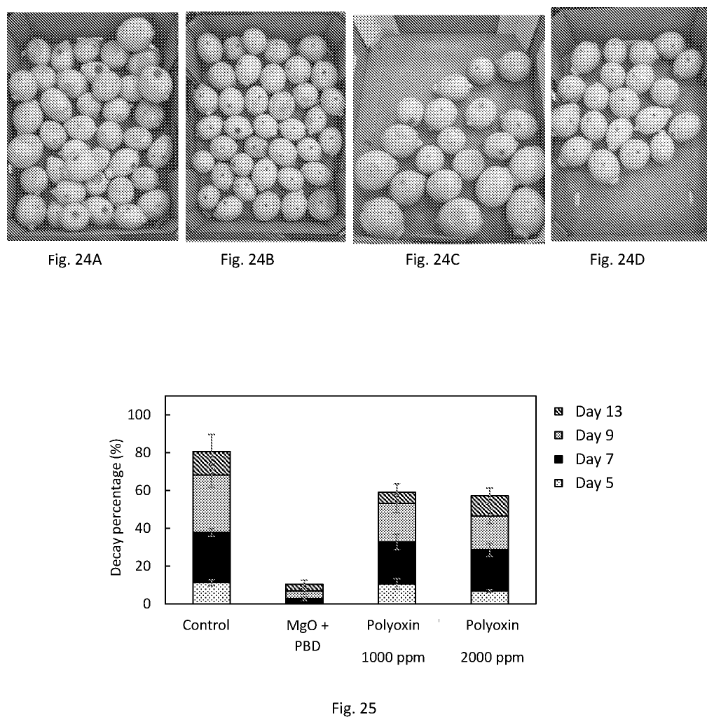

As demonstrated in FIG. 23, after a storage period of seven (7) days at 20° C., the decay level in fruits treated by a dispersion including MgO in combination with PBD was markedly lower than the decay level of un-treated fruits (group No. 1) and the decay level of fruits treated by a dispersion of Polyoxin at 1000 ppm and in addition, comparable to the decay level of fruits treated with a dispersion of Polyoxin at 2000 ppm. Appearance of fruits of the above four groups, after storage of five (5) days at 20° C. is shown in FIG. 24A through 24D for group No. 1 through group No. 4, respectively.

### Example 11

Comparing the effect of magnesium oxide in combination with PBD to the effect of polar on decay of infected oranges

The effect of applying on infected fruits a dispersion comprising MgO and phosphate-based dispersant (at 5%, and 0.125% by weight of the total weight of the dispersion) was next compared to the effect of applying on infected fruits the fungicide Polyoxin in wax (polar, at 1000 and 2000 ppm).

To this end, navel oranges were infected by Geotrichum candidum as detailed above (using a 5×10⁵ fungal culture), 24 hours before the application of treatment and stored meanwhile at a temperature of 5° C. The infected fruits were next divided into treatment groups as detailed in Table 13 below, each group including 40 fruit units, in quadmplicates.

TABLE 13
Treatment groups of navel oranges infected
with Geotrichum candidum

| Treatment | |
|---|---|
| group | Treatment type |
| 1 | Control |
| 2 | Coating with an aqueous dispersion comprising MgO (5%) |
| | and PBD (0.125%) |
| 3 | Coating with a solution comprising polar in wax (at 1000 |
| | ppm) |
| 4 | Coating with a solution comprising polar in wax (at 2000 |
| | ppm) |

As detailed in Table 13 above, the treatment program of the various groups was as follows. After the infection (24 hours), fruits were either left un-treated as a control (group No. 1) or coated by an aqueous dispersion comprising MgO and PBD (at 5%, and 0.125%, respectively, group No. 2). Fruits in treatment group No. 3 and No. 4 were subjected to coating by Polyoxin in wax (at 1000 or 2000 ppm, respectively). All of the fruit groups were then stored at 20° C. and the decay thereof was monitored after 5, 7, 9 and 13 days, as shown in FIG. 25.

As demonstrated in FIG. 25, after a 13-day storage period at 20° C., the decay level in fruits treated by a dispersion including MgO and PBD was markedly lower than the decay level observed in any of the other groups. Remarkably, the decay level of oranges treated by MgO and PBD as described above after the entire storage period (of 13 days) was comparable to the decay level in the other groups after just five days demonstrating that dipping the fruits in a MgO-based dispersion extends the shelf-life of fruit by at least two fold.

### Example 12

Comparing the Effect of Magnesium Oxide in Combination with PBD to the Effect of Polar on Decay of Infected Red Grapefruit

A similar effect to that observed in navel oranges was also demonstrated in red grapefruit, as detailed below.

Red grapefruits were infected by Geotrichum candidum as detailed above, 24 hours before the application of treatment and stored meanwhile at a temperature of 5° C. The infected fruits were next divided into treatment groups as detailed in Table 14 below, each group including 30 fruit units, in triplicates.

TABLE 14
Treatment groups of red grapefruits
infected with Geotrichum candidum

| Treatment | |
|---|---|
| group | Treatment type |
| 1 | Control |
| 2 | Coating with an aqueous dispersion comprising MgO (5%) |
| | and PBD (0.125%) |
| 3 | Coating with a solution comprising polar in wax (at 1000 |
| | ppm) |
| 4 | Coating with a solution comprising polar in wax (at 2000 |
| | ppm) |

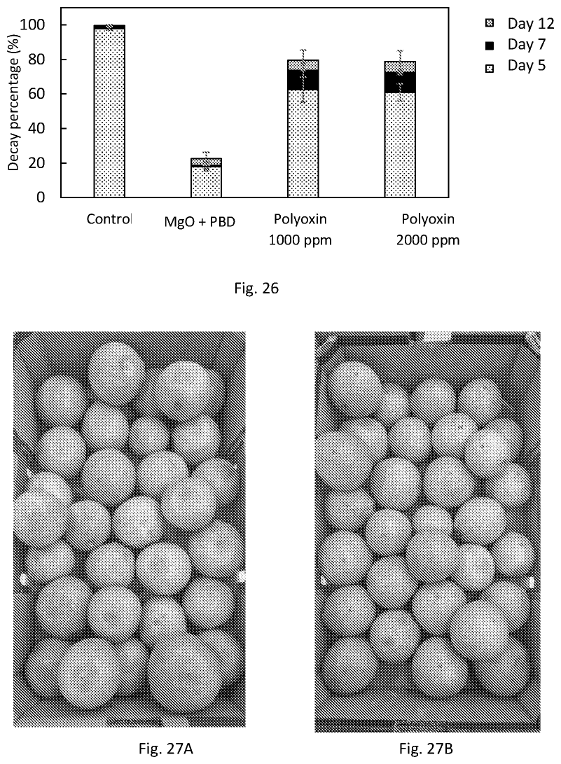

As detailed in Table 14 above, the treatment program of the various groups was as follows. After the infection (24 hours), fruits were either left un-treated as a control (group No. 1) or coated by an aqueous dispersion comprising MgO and PBD (at 5%, and 0.125%, respectively, group No. 2). Fruits in treatment group No. 3 and No. 4 were subjected to coating by Polyoxin in wax (at 1000 or 2000 ppm, respectively). All of the fruit groups were then stored at 25° C. and the decay thereof was monitored after 5, 7, and 12 days, as shown in FIG. 26.

As demonstrated in FIG. 26, after a 12-day storage period at 25° C., the decay level in fruits treated by a dispersion including MgO and PBD was about 4-fold lower than the decay level observed in the groups treated with Polyoxin. This effect is observable at all measurement points, demonstrating a clear extension of shelf-life for the infected fruits that were subjected to dipping in a MgO-based dispersion.

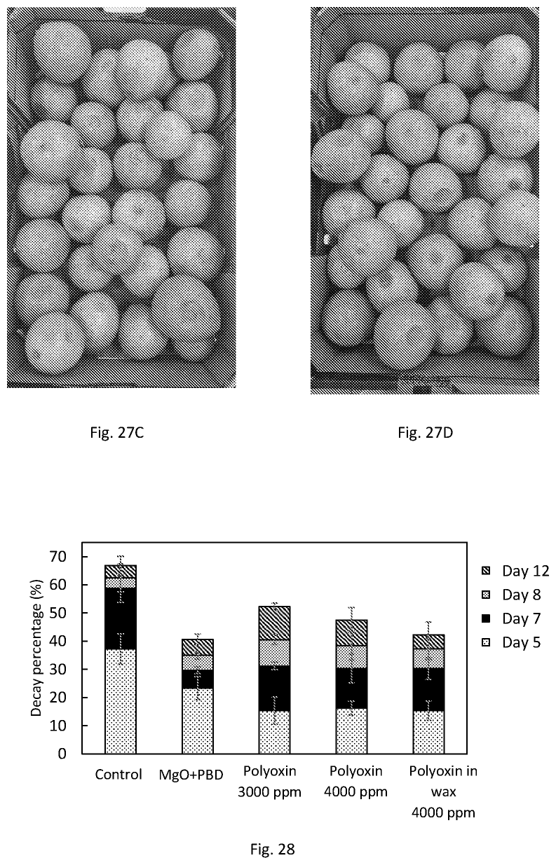

Appearance of fruits of the above four groups, after storage of seven (7) days at 25° C. is shown in FIG. 27A through 27D for group No. 1 through group No. 4, respectively.

### Example 13

Comparing the effect of magnesium oxide to the effect of polar on decay of infected clementines

The effect of applying on infected fruits a dispersion comprising MgO and PBD (at 5%, and 0.125%, respectively, by weight of the total weight of the dispersion) was next compared to the effect of applying on infected fruits the fungicide Polyoxin at higher concentrations (polar, at 3000 and 4000 ppm) or polar in wax (at 4000 ppm).

To this end, clementines (“Or”) were infected by Geotrichum candidum as detailed above, 24 hours before the application of treatment and stored meanwhile at a temperature of 5° C. The infected fruits were next divided into treatment groups as detailed in Table 14 below, each group including 40 fruit units, in quadruplicates.

TABLE 14
Treatment groups of clementines infected
with Geotrichum candidum

| Treatment | |
|---|---|
| group | Treatment type |
| 1 | Control |
| 2 | Coating with an aqueous dispersion comprising MgO (5%) |
| | and PBD (0.125%) |
| 3 | Coating with a solution comprising polar at 3000 ppm |
| 4 | Coating with a solution comprising polar at 4000 ppm |
| 5 | Coating with a solution comprising polar in wax (at 4000 |
| | ppm) |

As detailed in Table 14 above, the treatment program of the various groups was as follows. After the infection (24 hours), fruits were either left un-treated as a control (group No. 1) or coated by an aqueous dispersion comprising MgO and PBD (at 5% and 0.125%, respectively, group No. 2). Fruits in treatment group No. 3 and No. 4 were subjected to coating by Polyoxin at 3000 or 4000 ppm, respectively. Fruits in treatment group No. 5 was subjected to coating by Polyoxin in wax (at 4000 ppm). All of the fruit groups were then stored at 25° C. and the decay thereof was monitored after 5, 7, 8 and 12 days, as shown in FIG. 28.

As demonstrated in FIG. 28, after a 5-day storage period at 25° C., the decay level in fruits treated by a dispersion including MgO and PBD was higher than the decay level observed in any of the other groups treated with the fungicide Polyoxin. Remarkably, however, the decay level of the infected group treated by MgO and PBD as described above after the entire storage period (of 12 days) was comparable to the decay level in the other groups treated with the fungicide after just eight (8) days, demonstrating that dipping the fruits in a MgO-based dispersion clearly extends the shelf-life of infected fruit.

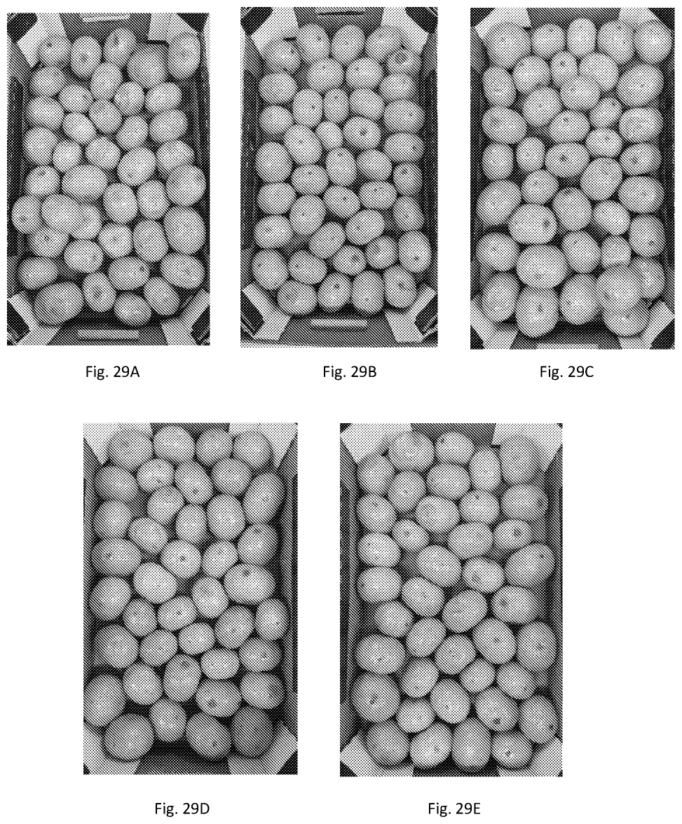

Appearance of fruits of the above five groups, after storage of eight (8) days at 25° C. is shown in FIG. 29A through 29E for group No. 1 through group No. 5, respectively.

### Example 14

Comparing the Effect of Magnesium Oxide in Combination with PBD to the Effect of Known Fungicides on Decay of Infected Navel (Newhall) Oranges

The effect of applying on infected fruits a dispersion comprising MgO and PBD (at 5% and 0.125%, respectively, by weight of the total weight of the dispersion) was next compared to the effect of applying on infected fruits the known fungicides Polyoxin or Guazatine in wax. In addition, the effect of a dispersion comprising MgO as a single agent (albeit in the presence of PBD) was compared to the effect of a dispersion comprising a combination of MgO and Polyoxin.

To this end, navel oranges (Newhall) were infected by Geotrichum candidum as detailed above, 24 hours before the application of treatment and stored meanwhile at a temperature of 5° C. The infected fruits were next divided into treatment groups as detailed in Table 15 below, each group including 25 fruit units, in quadruplicates

TABLE 15
Treatment groups of navel oranges (Newhall)
infected with Geotrichum candidum

| Treatment | |
|---|---|
| group | Treatment type |
| 1 | Control |
| 2 | Coating with an aqueous dispersion comprising MgO (5%) |
| | and PBD (0.125%) |
| 3 | Coating with a solution comprising polyoxin in wax (3000 |
| | ppm) |
| 4 | Coating with a solution comprising MgO (5%) and polyoxin |
| | (3000 ppm) |
| 5 | Coating with a solution comprising guazatine in wax (at |
| | 1500 ppm) |

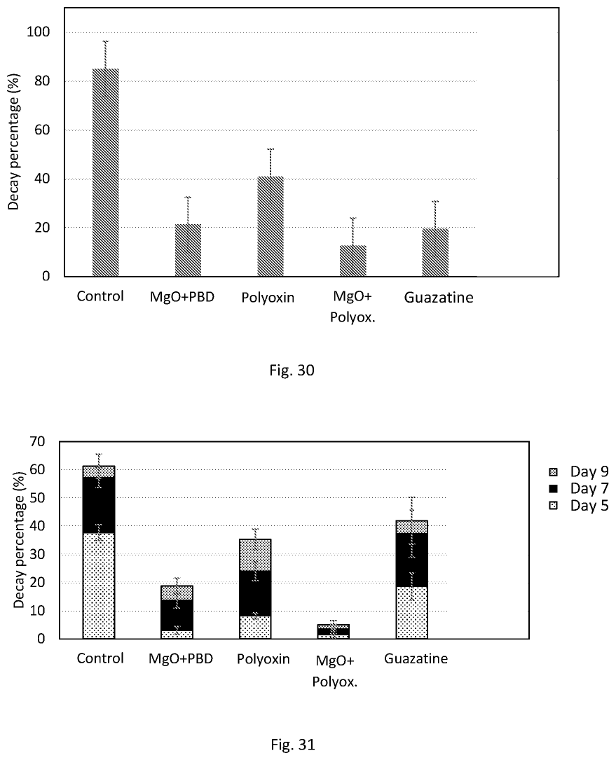

As detailed in Table 15 above, the treatment program of the various groups was as follows. After the infection (24 hours), fruits were either left un-treated as control (group No. 1) or coated by an aqueous dispersion comprising MgO and PBD, as detailed above (group No. 2). Fruits in treatment group No. 3 and No. 4 were subjected to coating by mixtures of Polyoxin (at 3000 ppm) in wax or in combination with MgO (which was at 5%), respectively. Fruits in treatment group No. 5 were subjected to coating by a solution comprising guazatine in wax (at 1500 ppm). All of the fruit groups were then stored at 25° C. and the decay thereof was monitored after 13 days, as shown in FIG. 30.

As demonstrated in FIG. 30, a dispersion comprising MgO and PBD was comparably effective to all fungicides tested in maintaining a low decay level in infected fruit. Apparently, MgO in combination with PBD was more effective than polyoxin when the latter was combined with wax and comparably effective to a combination of MgO and Polyoxin.

### Example 15

Comparing the Effect of Magnesium Oxide in Combination with PBD to the Effect of Known Fungicides on Decay of Infected Cara Cara Oranges

Further to the results presented above in Example 14, the effect of the various fungicides on decay in infected fruit was also tested in Cara Cara oranges.

Oranges (Cara Cara) were infected by Geotrichum candidum as detailed above, 24 hours before the application of treatment and stored meanwhile at a temperature of 5° C. The infected fruits were next divided into treatment groups as detailed in Table 16 below, each group including 20 fruit units, in five repeats.

TABLE 16
Treatment groups of Cara Cara oranges
infected with Geotrichum candidum

| Treatment | |
|---|---|
| group | Treatment type |
| 1 | Control |
| 2 | Coating with an aqueous dispersion comprising MgO (5%) |
| | and PBD (0.125%) |
| 3 | Coating with a solution comprising polyoxin in wax (3000 |
| | ppm) |
| 4 | Coating with a solution comprising MgO (5%) and polyoxin |
| | (3000 ppm) |
| 5 | Coating with a solution comprising guazatine in wax (at |
| | 1500 ppm) |

As detailed in Table 16 above, the treatment program of the various groups was as follows. After the infection (24 hours), fruits were either left un-treated as control (group No. 1) or coated by an aqueous dispersion comprising MgO and PBD (at 5% and 0.125%, respectively), as detailed above (group No. 2). Fruits in treatment group No. 3 and No. 4 were subjected to coating by mixtures of Polyoxin (at 3000 ppm) with wax or MgO (which was at 5%), respectively. Fruits in treatment group No. 5 were subjected to coating by a solution comprising guazatine in wax (at 1000 ppm). All of the fruit groups were then stored at 25° C. and the decay thereof was monitored after 5, 7 or 9 days, as shown in FIG. 31.

As demonstrated in FIG. 31, a dispersion comprising MgO in combination with PBD was more effective than the treatments by either wax-based mixtures of polyoxin or guazatine. Apparently, when combined together, MgO and Polyoxin had a synergistic effect in maintaining a low decay level in infected fruits.

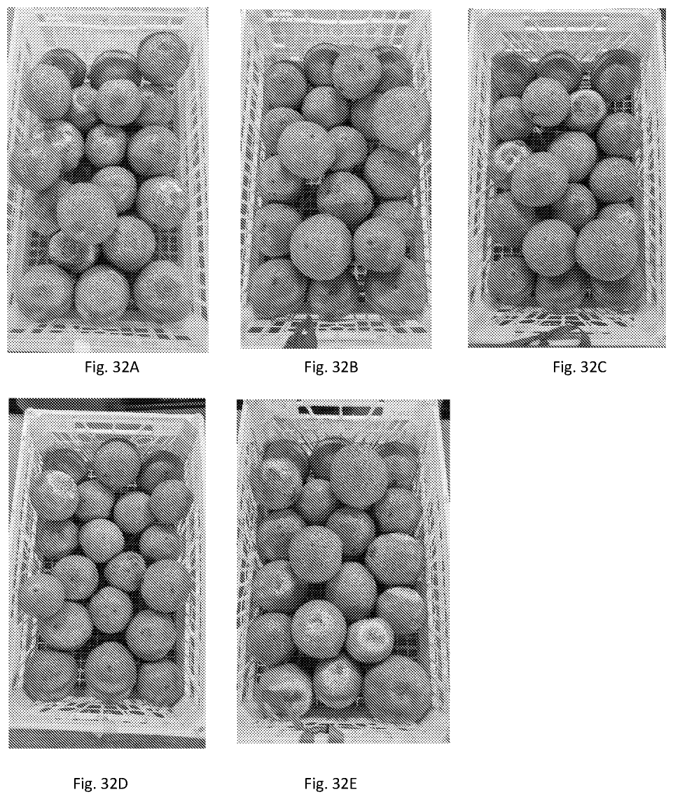

Appearance of fruits of the above six groups, after storage of seven (7) days at 25° C. is shown in FIG. 32A through 32E, for group No. 1 through group No. 5, respectively.

### Example 16

### Comparing the Effect of Magnesium Oxide and PBD, to the Effect of a Combination of Imazalil and TBZ on Decay of Infected White Grapefruits

The effect of applying on infected fruits a dispersion comprising MgO and PBD (at 5% and 0.125%, by weight of the total weight of the dispersion) was next compared to the effect of applying on infected fruits a combination of the known fungicides imazalil and TBZ.

To this end, white grapefruits were infected by Penicillium digitatum as detailed above, nine (9) days before the application of treatment and stored meanwhile at a temperature of 5° C. The infected fruits were next divided into treatment groups as detailed in Table 17 below, each group including 30 fruit units, in quadruplicates.

TABLE 17
Treatment groups of white grapefruits
infected with Penicillium disitatum

| Treatment | |
|---|---|
| group | Treatment type |
| 1 | Control |
| 2 | Coating with a solution comprising imazalil and TBZ (500 |
| | ppm and 3 ppm, respectively) |
| 3 | Coating with an aqueous dispersion comprising MgO (5%) |
| | and PBD (0.125%) |

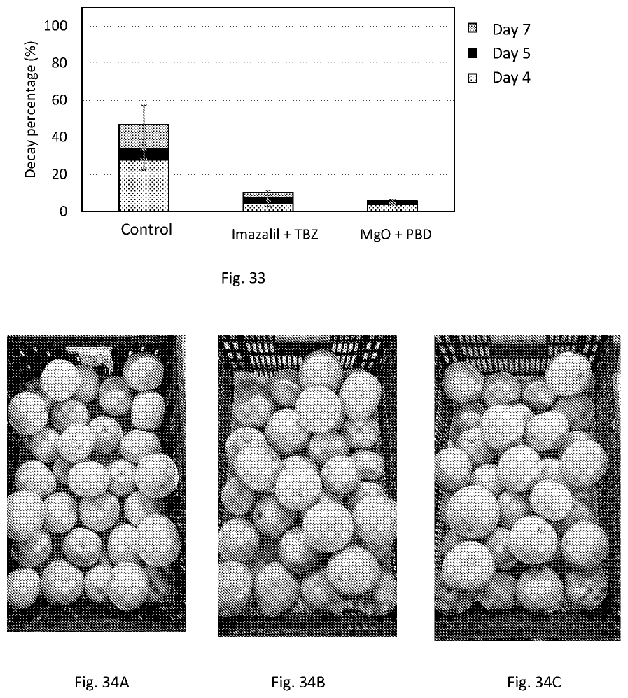

As detailed in Table 17 above, the treatment program of the various groups was as follows. After the infection (9 days) fruits were either left un-treated as control (group No. 1) or coated by an aqueous dispersion comprising MgO and PBD, as detailed above (group No. 3). Fruits in treatment group No. 2 were subjected to coating by imazalil and TBZ as indicated above. All of the fruit groups were then stored at 20° C. and the decay thereof was monitored after 4, 5 or 7 days, as shown in FIG. 33.

As demonstrated in FIG. 33, after a storage period of seven (7) days at 20° C., the decay levels in fruits treated by either a dispersion including MgO and PBD or the solution comprising the fungicidal combination of imazalil and TBZ were negligible as compared to the control group. Notably, these results were obtained albeit the prolonged storage of the infected fruit before the application of the agents thereon. Appearance of fruits of the above three groups, after storage of five (5) days at 20° C. is shown in FIG. 34A through 34C for group No. 1 through group No. 3, respectively.

### Example 17

### Comparing the Effect of Magnesium Oxide and PBD, to the Effect of a Combination of Imazalil and TBZ on Decay of Infected Mandarins

The comparison made in Example 16 was further performed using Mandarins. To this end, mandarins (Or) were also infected by Penicillium digitatum as detailed above, nine (9) days before the application of treatment and stored meanwhile at a temperature of 5° C. The infected fruits were next divided into treatment groups as detailed in Table 18 below, each group including 40 fruit units, in quadruplicates.

TABLE 18
Treatment groups of mandarins infected with Penicillium disitatum

| Treatment | |
|---|---|
| group | Treatment type |
| 1 | Control |
| 2 | Coating with a solution comprising imazalil and TBZ (500 |
| | ppm and 3 ppm, respectively) |
| 3 | Coating with an aqueous dispersion comprising MgO (5%) |
| | and PBD (0.125%) |

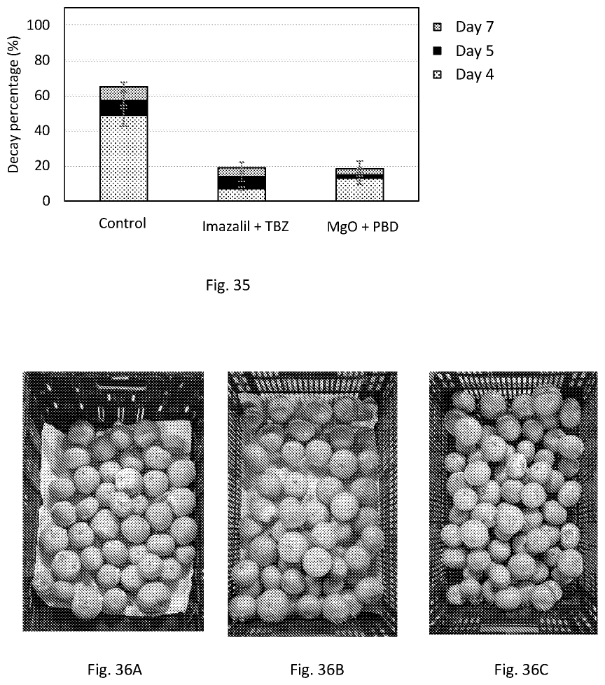

As detailed in Table 18 above, the treatment program of the various groups was as follows. After the infection (9 days), fruits were either left un-treated as control (group No. 1) or coated by an aqueous dispersion comprising MgO and PBD, as detailed above (group No. 3). Fruits in treatment group No. 2 were subjected to coating by imazalil and TBZ as indicated above. All of the fruit groups were then stored at 20° C. and the decay thereof was monitored after 4, 5 or 7 days, as shown in FIG. 35.

As demonstrated in FIG. 35, after a storage period of seven (7) days at 20° C., the decay levels in fruits treated by either a dispersion including MgO or a solution comprising the imazalil/TBZ fungicidal combination were three-fold lower than the decay level characterizing the control group. Notably, these results were obtained albeit the prolonged storage of the infected fruit before the application of the agents thereon.

Appearance of fruits of the above three groups, after storage of five (5) days at 20° C. is shown in FIG. 36A through 36C for group No. 1 through group No. 3, respectively.

### Example 18

### Examining the Effect of Magnesium Oxide on Fruits, Over Time

Finally, the effect of applying a dispersion comprising MgO and PBD (at 5% and 0.125%, respectively) was monitored over time on the decay percentage of kumquats, which were not inflicted with any injury or pathogenic agent, and compared to control fruits (on which such dispersion was not applied).

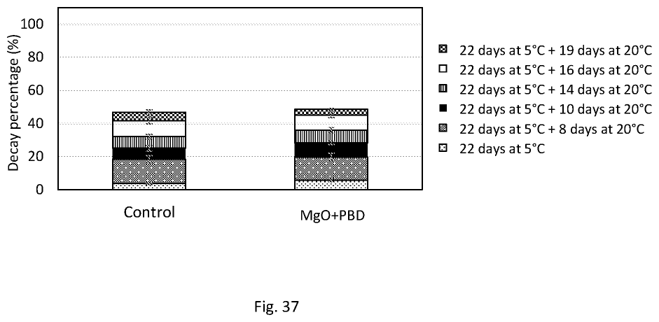

Kumquats were harvested, coated with a dispersion comprising MgO and PBD (at concentrations as indicated above) or left un-treated (control) and stored at a temperature of 5° C. for 22 days. The fruit were then moved to storage at 20° C. and the decay thereof was monitored after 8, 10, 14, 16 or 19 days, as shown in FIG. 37.

As evident from the results shown in FIG. 37, throughout the entire measurement period, the application of a dispersion comprising MgO (and the phosphate-based dispersant agent) per se had no effect on the decay percentage in kumquats, based on a comparison made to untreated fruits under the same conditions.

While the present disclosure has been illustrated and described with respect to a particular embodiment thereof, it should be appreciated by those of ordinary skill in the art that various modifications to this disclosure may be made without departing from the spirit and scope of the present disclosure.

1. A method of prolonging the shelf life of agricultural food products, comprising applying to the food products an aqueous dispersion comprising very slightly water soluble or water-insoluble magnesium compounds.

2. The method according to claim 1, wherein said aqueous dispersion further comprises at least one suspension aid.

3. The method according to claim 1, wherein the magnesium compound is magnesium oxide, magnesium hydroxide or a mixture thereof.

4. The method according to claim 1, wherein said agricultural food products comprise fruits and vegetables.

5. The method according to claim 1, wherein said agricultural food products comprise citrus fruits.

6. The method according to claim 1, wherein said at least one suspension aid is a phosphate-based dispersant.

7. The method according to claim 6, wherein the phosphate-based dispersant is a water-soluble salt selected from the group consisting of salts of phosphoric acid; salts of pyrophosphoric acid and salts of polyphosphoric acid.

8. The method according to claim 1, wherein said aqueous dispersion comprises at least 2% magnesium oxide and/or magnesium hydroxide and when present, at least 0.05% by weight of a suspension aid, based on the total weight of the dispersion.

9. The method according to claim 1, wherein said method comprises application of at least 0.1 gr magnesium oxide and/or magnesium hydroxide per 1 kg agricultural food products by immersing the food products in the dispersion or spraying the dispersion onto the food products.

10. The method according to claim 1, wherein said method comprises application of 0.1-5.0 gr magnesium oxide and/or magnesium hydroxide per 1 kg agricultural food products.

11. The method according to claim 1, further comprising at least one additional step, preferably a waxing step, a washing step, and/or applying to the food products at least one fungicide.

12. The method according to claim 1, for protecting said agricultural food products from decay by fungal infection and/or for controlling fungi on said agricultural food products.

13. The method according to claim 1, for prolonging the shelf life of citrus fruits, comprising applying to the citrus fruits an aqueous dispersion comprising at least 2% magnesium oxide and/or magnesium hydroxide and when present, at least 0.05% by weight of a suspension aid, based on the total weight of the dispersion, by immersing the food products in the dispersion or spraying the dispersion onto the food products.

14. The method according to claim 13 for protecting said citrus fruits from decay by fungal infection and/or for controlling fungi on said citrus fruits, wherein said fungal infection is caused by at least one of Penicillium digitatum, Penicillium italicum and Geotrichum candidum.

15. An aqueous dispersion comprising very slightly water soluble or water-insoluble magnesium compounds, for use in prolonging the shelf life of agricultural food products.

16. The aqueous dispersion according to claim 15, wherein said aqueous dispersion further comprises at least one suspension aid.

17. The aqueous dispersion according to claim 15, wherein the magnesium compound is magnesium oxide, magnesium hydroxide or a mixture thereof.

18. The aqueous dispersion according to claim 15, wherein said agricultural food products comprise fruits and vegetables.

19. The aqueous dispersion according to claim 15, wherein said agricultural food products comprise citrus fruits.

20. The aqueous dispersion according to claim 15, wherein said at least one suspension aid is a phosphate-based dispersant.

21. The aqueous dispersion according to claim 15, wherein said aqueous dispersion comprises at least 2% magnesium oxide and/or magnesium hydroxide and when present, at least 0.05% by weight of a suspension aid, based on the total weight of the dispersion.

22. The aqueous dispersion according to claim 15, wherein said aqueous dispersion protects said agricultural food products from decay by fungal infection and/or controls fungi on said agricultural food products.

23. The aqueous dispersion according to claim 15, wherein said aqueous dispersion comprises:
from 75 to 97.95% by weight of water,
from 2 to 15% by weight of MgO, Mg(OH)₂ or a mixture thereof; and optionally
from 0.05 to 3.0%, by weight of a phosphate-based dispersant.
